(19) United States
(12) Patent Application Publication
(10) Pub. No.: US 2024/0274914 A1
(43) Pub. Date: Aug. 15, 2024

(54) METHOD OF RECOVERING METAL IONS FROM BATTERIES

(71) Applicant: Nanyang Technological University, Singapore (SG)

(72) Inventors: Minh Phuong DO, Singapore (SG); Chor Yong TAY, Singapore (SG); Madhavi SRINIVASAN, Singapore (SG); Chiew Kei TAN, Singapore (SG)

(21) Appl. No.: 18/567,255

(22) PCT Filed: Jun. 8, 2022
(86) PCT No.: PCT/SG2022/050390

§ 371 Date: Dec. 5, 2023

(30) Foreign Application Priority Data
Jun. 8, 2021 (SG) 10202106101Q

(51) Int. Cl. H01M 10/54; C22B 3/16; C22B 3/18; C22B 7/00; C22B 26/12

(52) U.S. Cl. CPC H01M 10/54; C22B 3/165; C22B 3/18; C22B 7/007; C22B 26/12

(57) ABSTRACT

The present disclosure refers to a method of obtaining metal ions from a battery, the method comprising (i) adding fruit to a solvent to form a mixture; (ii) subjecting the mixture of step (i) to fermentation or heat treatment to obtain a leaching solution; and (iii) adding a crushed battery to the leaching solution to obtain a leachate comprising metal ions.

### TECHNICAL FIELD

The present disclosure refers to a method of obtaining metal ions from a battery. The present disclosure further refers to a method of obtaining metal salts from a battery. The present disclosure also refers to a method of recovering cathode material from lithium-ion batteries.

### BACKGROUND ART

Lithium-ion batteries (LIBs) are the most dominant types of secondary energy storage due to their compact sizes, high cyclability and high energy density. The demand and consumption of LIBs are expected to rise exponentially in the next decade. Based on current projections, the demand for essential LIB materials such as lithium, cobalt, nickel, and manganese will exceed their supply. Currently, most of the spent LIBs are disposed in municipal landfills, posing environmental hazards. To address the overwhelming pressure on natural resources, it is necessary to resolve the problems associated with LIB waste and to reliably recover the precious metals from battery cathode materials.

Pyrometallurgy, hydrometallurgy and biometallurgy are the three main methods to recycle spent LIBs. Pyrometallurgy is an effective method to extract metals. However, due to the high amount of heat and energy involved in the process, it may be counter-intuitive to use it for recycling. Meanwhile, biometallurgy has limitations due to scalability.

In terms of metal recovery, hydrometallurgy requires less energy compared to pyrometallurgy and allows for more robustness in handling various metal compositions. In this process, after treatment, the cathode and anode materials are separated from the battery casing, separator, and current corrector. Acid is often used to leach cathode materials in the form of metal ions. Conventionally, the leaching agent comprises an acid solution (inorganic/organic acid) and a reducing agent (e.g., H₂O₂, glucose, NaHSO₃). The leaching efficiency of Li ions is strongly correlated to the acid strength whereas leaching efficiencies of cathode transition metals are more complicated as they require reductants to aid the reduction from the +3/+4 valence states to the divalent state. H₂O₂ is usually reported to be used with acid in cathode leaching reactions.

Even though hydrometallurgy is more economical for industrial uses, the use of acids in the hydrometallurgical reactions can produce substantial acid wastes, thereby causing secondary pollution to the environment. High acidity inreactionvessels also pose corrosive hazards. In literature, leaching using organic acids has been explored due to their biodegradability, lower acidity, and reduced corrosion. However, the usage of organic acids is still confined because of their high costs.

Thus, there is a need to find new methods of recovering metal ions from batteries that overcome or ameliorate these problems.

### SUMMARY

In one aspect of the present disclosure, there is provided a method of obtaining metal ions from a battery, the method comprising:
(i) adding fruit to a solvent to form a mixture;
(ii) subjecting the mixture of step (i) to fermentation or heat treatment to obtain a leaching solution; and
(iii) adding a crushed battery to the leaching solution thereby obtaining a leachate comprising metal ions.

In another aspect of the present disclosure, there is provided a method of obtaining a metal salt from a battery, the method comprising:
(i) adding fruit to a solvent to form a mixture;
(ii) subjecting the mixture of step (i) to fermentation or heat treatment to obtain a leaching solution;
(iii) adding a crushed battery to the leaching solution thereby obtaining a leachate comprising metal ions; and
(iv) adding a precipitating agent to the leachate to obtain a precipitate comprising the metal salt.

In a further aspect of the present disclosure, there is provided a method of recovering and regenerating a lithium cathode material from a lithium-ion battery (LIB), the method comprising: (i) adding fruit to a solvent to form a mixture;
(ii) subjecting the mixture of step (i) to fermentation or heat treatment to obtain a leaching solution;
(iii) adding a crushed LIB to the leaching solution thereby obtaining a leachate comprising metal ions;
(iv) adding a precipitating agent to the leachate of step (iii), thereby obtaining a precipitate comprising metal salt; and
(v) mixing the precipitate of step (iv) with a lithium salt and heating the resulting mixture to obtain a lithium cathode material.

The present disclosure describes treatment methods to convert fruit waste to produce extracts that can be utilised for hydrometallurgical leaching of black masses. The presently disclosed method advantageously does not require significant energy to treat fruit and thus has a smaller energy footprint compared to other conventional methods like pyrometallurgy.

The presently disclosed method also does not require huge amounts of acid like HCl, H₂SO₄, citric acid, acetic acid, nor does it require a secondary oxidant like H₂O₂ in order to effectively leach metal ions from crushed batteries. Hence, the presently disclosed method not only saves costs, but is also eco-friendly.

The presently disclosed method by virtue of not requiring a secondary acid or oxidant, also does not produce corrosive, hazardous and/or toxic waste that require neutralisation prior to disposal which is an added advantage over conventional methods that require waste treatment after leaching.

In the presently disclosed method, the active compounds produced after treatment function both as acids as well as reductants, thus eliminating the need for a secondary acid and/or oxidant to be added. However, the leaching reaction/efficiency using the leaching solution of the present disclosure may be enhanced further by adding a small amount of acid as additive. The addition of a small amount of acid does not result in strongly acidic waste being produced and thus does not require extra waste treatment procedures which result in further costs and impact on the environment.

The presently disclosed method also uses two common types of waste i.e., fruit waste and LIBs, while producing valuable metal ions in the process. The method thus creates economic value out of waste products that would previously have been simply disposed of in landfills or by incineration, and is a remarkable step towards a circular economy and zero-waste society.

The presently disclosed method also produces a leachate of moderate pH (>3). This pH range solubilises valuable metals like Li, Mn, Ni, Co while inhibiting the dissolution of other metals like Cu and Al. This means that the other impurity metals may be simply filtered out prior to precipitation of the valuable metals. The metals recovered via precipitation can also be directly implemented for cathode regeneration without any impurity removal process required. This advantageously results in lower costs and ease of use.

The presently disclosed method may involve a step of fermenting the fruit to obtain a leaching solution. Fruit waste is first treated by fermentation to extract and convert biomass to valuable soluble organic acids and antioxidant compounds. The disclosed method does not require any energy input, merely utilising nature to break down the components in fruit waste to form active compounds. Hence, the method, not requiring any energy input, is advantageously more eco-friendly than other conventional methods.

The presently disclosed method may also use heat treatment to convert the components in fruit waste into active compounds. While the process requires some heat input, the energy input has a smaller footprint on the environment as compared to conventional methods requiring strong acids and/or oxidants.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, the term “black mass” refers to shredded and/or crushed components of a battery (such as metal-ion batteries) containing cathode, anode, plastic binder, battery shell and/or other components of a battery.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIGS. 1A and 1B are schemes outlining methods of treating fruit waste of the present invention.

FIG. 2a is a graph showing the Proton-Nuclear Magnetic Resonance (¹H-NMR) spectrum of orange peel extract after fermentation.

FIG. 2b is a graph showing the Heteronuclear Multiple Bond Correlation (HMBC) spectrum of orange peel extract after fermentation.

FIG. 3 is a graph showing the Fourier-Transform Infrared Spectroscopy (FT-IR) spectrum of fruit extract after fermentation.

FIG. 4a is a graph showing the Liquid Chromatography-Mass Spectrometry (LC-MS) results for lactic acid (RT: 1.54 minutes) in orange peel extract after fermentation and hydrolysis.

FIG. 4b is a graph showing the LC-MS result for ascorbic acid (RT: 1.47 minutes) in orange peel extract after fermentation and hydrolysis.

FIG. 4c is a graph showing the LC-MS result for citric acid (RT: 1.48 minutes) in orange peel extract after fermentation and hydrolysis.

FIG. 4d is a graph showing the LC-MS result for gluconic acid (RT: 1.44 minutes) in orange peel extract after fermentation and hydrolysis.

FIG. 5a is a graph showing the 2,2-diphenyl-1-picryl-hydmzyl-hydrate (DPPH) scavenging assay results of fruit extract after fermentation.

FIG. 5b is a graph showing the 2,2′-azinobis-(3-ethylbenzothiazoline-6-sulfonic acid) (ABTS) scavenging assay results of fruit extracts after fermentation.

FIG. 5c is a graph showing the Ferric Reducing Antioxidant Power (FRAP) assay results of fruit extracts after fermentation.

FIG. 6 is a graph showing the leaching efficiency of orange extracts treated by different means.

FIG. 7 is a graph showing the leaching efficiency and pH of fermented orange extracts over time.

FIG. 8a is a graph showing the leaching efficiency of fermented orange extracts on Co-rich black mass over time.

FIG. 8b is a graph showing the leaching efficiency of orange extracts which had undergone microwave-assisted treatment on NMC black mass over time.

FIG. 9a is a graph showing the effect of the initial pH of the fruit waste extracts on leaching efficiency.

FIG. 9b is a graph showing the effect of the leaching temperature on leaching efficiency.

FIG. 9c is a graph showing the effect of leaching temperature on leaching efficiency of hydrothermally treated orange extract on NMC black mass.

FIG. 9d is a graph showing the effect of leaching temperature on leaching efficiency of microwave-treated orange extract on NMC black mass.

FIG. 10a is a graph showing the leaching efficiency of fermented fruit extracts at 100° C.

FIG. 10b is a graph showing the leaching efficiency of fermented fruit extracts at different leaching temperatures.

FIG. 11a is a graph showing the absolute concentration of metal ions in the leachate from fermented orange extract at different loading capacities of black mass.

FIG. 11b is a graph showing the leaching efficiency of fermented orange extract sorted by metals.

FIG. 12a is a graph showing the absolute concentration of metal ions in the leachate from fermented papaya extract at different loading capacities of black mass.

FIG. 12b is a graph showing the leaching efficiency of fermented papaya extract by different metals.

FIG. 13a is a graph showing the absolute concentration of metal ions in the leachate from fermented pomelo extract at different loading capacities of black mass.

FIG. 13b is a graph showing the leaching efficiency of fermented pomelo extract by different metals.

FIG. 14a is a graph showing the absolute concentration of metal ions in the leachate from fermented mango extract at different loading capacities of black mass.

FIG. 14b is a graph showing the leaching efficiency of fermented mango extract by different metals.

FIG. 15a is a graph showing the absolute concentration of metal ions in the leachate from fermented pineapple extract at different loading capacities of black mass.

FIG. 15b is a graph showing the leaching efficiency of fermented pineapple extract by different metals.

FIG. 16a is a graph showing the absolute concentration of metal ions in the leachate from fermented honeydew extract at different loading capacities of black mass.

FIG. 16b is a graph showing the leaching efficiency of fermented honeydew extract by different metals.

FIG. 17 is a graph showing the leaching efficiency of fermented orange extract of different concentrations.

FIG. 18 is a graph showing the leaching efficiency of fermented orange extract with HCl as additive.

FIG. 19 is a graph showing the leaching efficiency of fermented orange extract with HCl and citric acid as additive.

FIG. 20 is a graph showing the leaching efficiency of fermented orange extract with HCl on Nickel Manganese Cobalt (NMC) black mass.

FIG. 21 is a graph showing the leaching efficiency of fermented orange extract with HCl on Ni-rich black mass.

FIG. 22 is a graph showing the leaching efficiencies of orange extract produced from various heat treatments with HCl on Co-rich black mass.

FIG. 23a is a graph showing the X-Ray Diffraction (XRD) spectrum of battery waste.

FIG. 23b is a graph showing the Energy-dispersive X-ray (EDX) spectrum of battery waste.

FIG. 24a is a graph showing the time-dependent pH of the fruit extract undergoing hydrolysis.

FIG. 24b is a graph showing the FRAP assay of the fruit extracts after hydrolysis for different durations.

FIG. 25a is a graph showing the FRAP assay of the fruit extracts after hydrothermal treatment for different durations, with a fruit extract which had undergone hydrolysis as reference.

FIG. 25b is a graph showing the FRAP assay of the fruit extracts after hydrothermal treatment at different temperatures.

FIG. 26a is a graph showing the FRAP assay of the fruit extracts after microwave-assisted treatment at different temperatures.

FIG. 26b is a graph showing the FRAP assay of the fruit extracts after microwave-assisted treatment for different durations.

FIG. 27 is a graph showing the leaching efficiency of microwave-treated orange extracts on NMC black mass at different slurry densities.

FIG. 28 is a graph showing the leaching efficiency of heat-treated orange extracts on NMC black mass.

### DETAILED DISCLOSURE OF EMBODIMENTS

The present disclosure refers to a method of obtaining metal ions from a battery, the method comprising:
(i) adding fruit to a solvent to form a mixture;
(ii) subjecting the mixture of step (i) to fermentation or heat treatment to obtain a leaching solution; and
(iii) adding a crushed battery to the leaching solution thereby obtaining a leachate comprising metal ions.

Considering the abundance of high value organic acids from fruit waste, the motivation was to devise a treatment step with the aim to extract the organic acids and antioxidants for direct use in the LIB hydrometallurgy process without any other chemical additions.

The inventors of the present disclosure have surprisingly found that by subjecting fruit waste to various treatments, the resulting mixture may be used to leach metal ions from battery waste without requiring an additional inorganic and/or organic acid. In a sense, the present invention can selectively extract valuable metals (Co, Mn, Ni, Li) from battery waste with high effectiveness without the aid of other leaching agents (acids or reductants). The present invention also describes various treatment methods for fruit peel wastes to produce extracts, which can effectively be utilized for the hydrometallurgical processing of LIB black mass. The invention reported herein can resolve the persistent technical hindrance in hydrometallurgy by providing a green process which operates efficiently in metals extraction without recourse to corrosive inorganic acids nor inorganic reducing agents (e.g., H₂O₂, NaHSO₃).

Compared to presently known methods that require the use of significant amounts of strong inorganic acids like sulphuric acid, hydrochloric acid, or organic acids like acetic acid, citric acid, tartaric acid among others, the presently disclosed method has comparatively lower reagent costs. The presently disclosed method also eliminates the need to deal with acidic by-products from the usage of such inorganic and/or organic acids. The present disclosure has also demonstrated that while leaching efficiency is already comparable without the presence of acid, small amounts of acid additive may still be added to the leaching solution for a surprising improvement in leaching efficiency. By using only up to 10% of the acid used in conventional leaching methods, a comparable or even better leaching efficiency can be achieved.

The battery may be any metal ion battery, such as aluminium ion batteries, lithium ion batteries, potassium ion batteries, magnesium ion batteries, zinc ion batteries or sodium ion batteries. The metal ions of the metal ion battery may be selected from the group consisting of aluminium ions, lithium ions, potassium ions, magnesium ions, zinc ions, sodium ions, and combinations thereof. In some embodiments, the battery may be an NMC 111 (LiNiₓMn_{y}Co_{z}O2, x=y=z=0.3) battery, an NMC 622 (LiNiₓMn_{y}Co_{z}O2, x=0.6, y=z=0.2) battery, a Lithium Nickel Cobalt Aluminum Oxide (e.g. LiNi_{0.8}Co_{0.15}Al_{0.05}O₂) battery, a Lithium Cobalt Oxide (e.g. LiCoO₂) battery, a Lithium Nickel Oxide (e.g. LiNiO₂) battery, a Lithium Manganese Oxide (e.g. LiMn₂O₄) battery, a Lithium Nickel Manganese Cobalt Oxide (e.g. LiNi_{0.33}Mn_{0.3}Co_{0.3}O₂) battery, a lithium titanate battery, a lithium iron phosphate battery, a lithium manganese dioxide battery, a lithium manganese nickel battery, a lithium manganese phosphate battery, a lithium nickel phosphate battery, a lithium cobalt phosphate battery, a lithium-ion polymer battery, a thin-film lithium-ion battery, a lithium silicon battery, or an NMC 811 (LiNiₓMn_{y}Co_{z}O₂, x=0.8, y=z=0.1) battery or combinations and mixtures thereof. In certain preferred embodiments, the battery is selected from Lithium Nickel Cobalt Aluminum Oxide (e.g. LiNi_{0.8}Co_{0.15}Al_{0.05}O₂), Lithium Cobalt Oxide (e.g. LiCoO₂), Lithium Nickel Oxide (e.g. LiNiO₂), Lithium Manganese Oxide (e.g. LiMn₂O₄), Lithium Nickel Manganese Cobalt Oxide (e.g. LiNi_{0.33}Mn_{0.3}Co_{0.3}O₂) and mixtures thereof.

The crushed battery may be obtained by shredding, pulverizing, grinding, cutting and/or blending a battery. The battery may be fully discharged prior to shredding, pulverizing, grinding, cutting and/or blending. The battery may be shredded, pulverized, grinded, cut and/or blended without prior dismantling. The crushed battery may be obtained using any instrument and machinery that can break, cut shred, grind, pulverize and/or blend a battery, such as a shaft shredder, pre-chopper, mechanism cutter, or battery cutter. The crushed battery may be sieved to remove any plastic constituents. The resulting sieved crushed battery may be in particulate form. The particulate form may be a black mass particulate.

In some embodiments, an acid is not further added to the leaching solution of step (ii). In some other embodiments an acid is added in a small concentration to enhance its leaching properties.

In some embodiments, treating fruit waste comprises subjecting fruit waste to various treatments such that monosaccharides, disaccharides and polysaccharides in fruit waste will be converted into hydroxy acids, fatty acids, furfural, phenolic compounds or aldehydes. The acids produced during treatment of fruit waste may comprise lactic acid, glycolic acid, citric acid, malic acid, tartaric acid, succinic acid, benzoic acid, ascorbic acid, quininic acid, gluconic acid and any combinations and mixtures thereof. Reducing compounds produced during treatment of fruit waste may comprise ascorbic acid, lactic acid, citric acid, phenolics, flavonoids, reducing sugars, glucose, fructose, and combinations and mixtures thereof. In certain preferred embodiments, compounds formed from treating agricultural waste, especially fruit waste may comprise citric acid, lactic acid, acetic acid, ascorbic acid, gluconic acid and combinations and mixtures thereof. In other preferred embodiments, the reducing compounds produced from treating fruit waste may comprise ascorbic acid, lactic acid, citric acid, phenolic compounds, flavonoids, reducing sugars, and combinations and mixtures thereof.

The compounds produced during treatment not only work as acid sources in the battery leaching process, but also as reductants. As mentioned above, as the compounds produced can function as acid sources, a secondary acid may not be required to effect leaching of the metals in battery waste. Apart from a smaller waste output that is generated in the present invention, lower amounts of fruit waste will also be required for the presently disclosed process. While the supernatant obtained after treating the fruit may be used as-is for the leaching process, the residue obtained after the treatment may also be used for other applications, such as animal feed. Hence, one of the results of the present invention is to fully utilise all components of agricultural waste, such as fruit waste in order to reduce landfill and incineration usage. While the residue could be utilized for animal feed, the supernatant is applied directly for battery waste hydrometallurgy without any other addition of chemicals. In some embodiments, the supernatant of the treatment process is used without further modifications in the leaching step, while in other embodiments, the residue after treatment may be used in other applications like animal feed.

The pH of the leaching solution may be at least about 3, at least about 3.31, at least about 3.32, at least about 3.4, at least about 3.59, at least about 3.62, at least about 3.73, at least about 3.8, at least about 3.84, at least about 3.9, at least about 4.1, at least about 4.4, at least about 4.9, at least about 5, at least about 5.1, at least about 6; or from about 3 to about 6, from about 3 to about 5.1, from about 3 to about 5, from about 3 to about 4.9, from about 3 to about 4.4, from about 3 to about 4.1, from about 3 to about 3.9, from about 3 to about 3.84, from about 3 to about 3.8, from about 3 to about 3.73, from about 3 to about 3.62, from about 3 to about 3.59, from about 3 to about 3.4, from about 3 to about 3.32, from about 3 to about 3.31, from about 3.31 to about 6, from about 3.31 to about 5.1, from about 3.31 to about 5, from about 3.31 to about 4.9, from about 3.31 to about 4.4, from about 3.31 to about 4.1, from about 3.31 to about 3.9, from about 3.31 to about 3.84, from about 3.31 to about 3.8, from about 3.31 to about 3.73, from about 3.31 to about 3.62, from about 3.31 to about 3.59, from about 3.31 to about 3.4, from about 3.31 to about 3.32, from about 3.32 to about 6, from about 3.32 to about 5.1, from about 3.32 to about 5, from about 3.32 to about 4.9, from about 3.32 to about 4.4, from about 3.32 to about 4.1, from about 3.32 to about 3.9, from about 3.32 to about 3.84, from about 3.32 to about 3.8, from about 3.32 to about 3.73, from about 3.32 to about 3.62, from about 3.32 to about 3.59, from about 3.32 to about 3.4, from about 3.4 to about 6, from about 3.4 to about 5.1, from about 3.4 to about 5, from about 3.4 to about 4.9, from about 3.4 to about 4.4, from about 3.4 to about 4.1, from about 3.4 to about 3.9, from about 3.4 to about 3.84, from about 3.4 to about 3.8, from about 3.4 to about 3.73, from about 3.4 to about 3.62, from about 3.4 to about 3.59, from about 3.59 to about 6, from about 3.59 to about 5.1, from about 3.59 to about 5, from about 3.59 to about 4.9, from about 3.59 to about 4.4, from about 3.59 to about 4.1, from about 3.59 to about 3.9, from about 3.59 to about 3.84, from about 3.59 to about 3.8, from about 3.59 to about 3.73, from about 3.59 to about 3.62, from about 3.62 to about 6, from about 3.62 to about 5.1, from about 3.62 to about 5, from about 3.62 to about 4.9, from about 3.62 to about 4.4, from about 3.62 to about 4.1, from about 3.62 to about 3.9, from about 3.62 to about 3.84, from about 3.62 to about 3.8, from about 3.62 to about 3.73, from about 3.73 to about 6, from about 3.73 to about 5.1, from about 3.73 to about 5, from about 3.73 to about 4.9, from about 3.73 to about 4.4, from about 3.73 to about 4.1, from about 3.73 to about 3.9, from about 3.73 to about 3.84, from about 3.73 to about 3.8, from about 3.8 to about 6, from about 3.8 to about 5.1, from about 3.8 to about 5, from about 3.8 to about 4.9, from about 3.8 to about 4.4, from about 3.8 to about 4.1, from about 3.8 to about 3.9, from about 3.8 to about 3.84, from about 3.84 to about 6, from about 3.84 to about 5.1, from about 3.84 to about 5, from about 3.84 to about 4.9, from about 3.84 to about 4.4, from about 3.84 to about 4.1, from about 3.84 to about 3.9, from about 3.9 to about 6, from about 3.9 to about 5.1, from about 3.9 to about 5, from about 3.9 to about 4.9, from about 3.9 to about 4.4, from about 3.9 to about 4.1, from about 4.1 to about 6, from about 4.1 to about 5.1, from about 4.1 to about 5, from about 4.1 to about 4.9, from about 4.1 to about 4.4, from about 4.4 to about 6, from about 4.4 to about 5.1, from about 4.4 to about 5, from about 4.4 to about 4.9, from about 4.9 to about 6, from about 4.9 to about 5.1, from about 4.9 to about 5, from about 5 to about 6, from about 5 to about 5.1, from about 5.1 to about 6; or at most about 3, at most about 3.31, at most about 3.32, at most about 3.4, at most about 3.59, at most about 3.62, at most about 3.73, at most about 3.8, at most about 3.84, at most about 3.9, at most about 4.1, at most about 4.4, at most about 4.9, at most about 5, at most about 5.1, at most about 6; or about 3, about 3.31, about 3.32, about 3.4, about 3.59, about 3.62, about 3.73, about 3.8, about 3.84, about 3.9, about 4.1, about 4.4, about 4.9, about 5, about 5.1, about 6, or any ranges or values therebetween. In a preferred embodiment, the pH of the leaching solution may be from about 3 to about 5.

In some embodiments, treating the fruit comprises fermenting, heat treatment, or combinations thereof. Heat treating (treatment) may comprise any method of exposing the fruit to heat to induce the conversion of saccharides to the key compounds as mentioned above. In some embodiments, heat treating may comprise hydrolysis, hydrothermal treating, microwave-assisted treating or combinations thereof. In a preferred embodiment, treating the fruit comprises fermenting, hydrolysis, microwave-assisted treating, hydrothermal treating or combinations thereof.

The fermentation process may be performed simply by letting the agricultural and/or food waste ferment. The process may also be accelerated, catalysed, induced and/or promoted by use of a fermentation starter. The fermentation starter may be a general fermentation starter that finds general use in convention fermentation process, or may comprise components specially designed to work on the components found in the agricultural and/or food waste. In some embodiments, the fermentation starter may be selected from the group consisting of whey, yeast, kombucha, kefir, sourdough, residue from a previous fermentation step (ii), residue from other fermentation processes or bacterial strains selected from the group consisting of Acetobacters, Escherichia, Citrobacter, Enterobacter, Klebsiella, Lactobacillaceae and Streptococcacea, and combinations and mixtures thereof. Fermenting the agricultural and/or fruit waste brings many advantages. Lower energy footprint is associated with fermentation as external heat input is not required. In some preferred embodiments, the fermentation starter is whey protein.

The present disclosure hence discloses a method comprising fermenting the fruit to obtain the leaching solution. The present disclosure also discloses a method further comprising adding a fermentation starter.

In some embodiments, the fruit is fermented for a certain duration, for at least about 1 day, at least about 2 days, at least about 3 days, at least about 4 days, at least about 5 days, at least about 6 days, at least about 7 days, or from about 1 day to about 7 days, from about 1 day to about 6 days, from about 1 day to about 5 days, from about 1 day to about 4 days, from about 1 day to about 3 days, from about 1 day to about 2 days, from about 2 days to about 7 days, from about 2 days to about 6 days, from about 2 days to about 5 days, from about 2 days to about 4 days, from about 2 days to about 3 days, from about 3 days to about 7 days, from about 3 days to about 6 days, from about 3 days to about 5 days, from about 3 days to about 4 days, from about 4 days to about 7 days, from about 4 days to about 6 days, from about 4 days to about 5 days, from about 5 days to about 7 days, from about 5 days to about 6 days, from about 6 days to about 7 days, or at most about 1 day, at most about 2 days, at most about 3 days, at most about 4 days, at most about 5 days, at most about 6 days, at most about 7 days, or about 1 day, about 2 days, about 3 days, about 4 days, about 5 days, about 6 days, about 7 days, or any ranges or values therebetween. In a preferred embodiment, the fruit is fermented for about 3 days.

The present disclosure hence discloses a method, comprising fermenting the fruit for about 3 days.

Step (ii) of the disclosed method may comprise heating the mixture at a temperature of at least about 50° C., at least about 60° C., at least about 70° C., at least about 80° C., at least about 90° C., at least about 100° C., at least about 120° C., at least about 140° C., at least about 160° C., at least about 180° C., at least about 200° C., at least about 205° C., at least about 210° C., at least about 215° C., at least about 220° C., or from about 50° C. to about 220° C., from about 50° C. to about 215° C., from about 50° C. to about 210° C., from about 50° C. to about 205° C., from about 50° C. to about 200° C., from about 50° C. to about 180° C., from about 50° C. to about 160° C., from about 50° C. to about 140° C., from about 50° C. to about 120° C., from about 50° C. to about 100° C., from about 50° C. to about 90° C., from about 50° C. to about 80° C., from about 50° C. to about 70° C., from about 50° C. to about 60° C., from about 60° C. to about 220° C., from about 60° C. to about 215° C., from about 60° C. to about 210° C., from about 60° C. to about 205° C., from about 60° C. to about 200° C., from about 60° C. to about 180° C., from about 60° C. to about 160° C., from about 60° C. to about 140° C., from about 60° C. to about 120° C., from about 60° C. to about 100° C., from about 60° C. to about 90° C., from about 60° C. to about 80° C., from about 60° C. to about 70° C., from about 70° C. to about 220° C., from about 70° C. to about 215° C., from about 70° C. to about 210° C., from about 70° C. to about 205° C., from about 70° C. to about 200° C., from about 70° C. to about 180° C., from about 70° C. to about 160° C., from about 70° C. to about 140° C., from about 70° C. to about 120° C., from about 70° C. to about 100° C., from about 70° C. to about 90° C., from about 70° C. to about 80° C., from about 80° C. to about 220° C., from about 80° C. to about 215° C., from about 80° C. to about 210° C., from about 80° C. to about 205° C., from about 80° C. to about 200° C., from about 80° C. to about 180° C., from about 80° C. to about 160° C., from about 80° C. to about 140° C., from about 80° C. to about 120° C., from about 80° C. to about 100° C., from about 80° C. to about 90° C., from about 90° C. to about 220° C., from about 90° C. to about 215° C., from about 90° C. to about 210° C., from about 90° C. to about 205° C., from about 90° C. to about 200° C., from about 90° C. to about 180° C., from about 90° C. to about 160° C., from about 90° C. to about 140° C., from about 90° C. to about 120° C., from about 90° C. to about 100° C., from about 100° C. to about 220° C., from about 100° C. to about 215° C., from about 100° C. to about 210° C., from about 100° C. to about 205° C., from about 100° C. to about 200° C., from about 100° C. to about 180° C., from about 100° C. to about 160° C., from about 100° C. to about 140° C., from about 100° C. to about 120° C., from about 120° C. to about 220° C., from about 120° C. to about 215° C., from about 120° C. to about 210° C., from about 120° C. to about 205° C., from about 120° C. to about 200° C., from about 120° C. to about 180° C., from about 120° C. to about 160° C., from about 120° C. to about 140° C., from about 140° C. to about 220° C., from about 140° C. to about 215° C., from about 140° C. to about 210° C., from about 140° C. to about 205° C., from about 140° C. to about 200° C., from about 140° C. to about 180° C., from about 140° C. to about 160° C., from about 160° C. to about 220° C., from about 160° C. to about 215° C., from about 160° C. to about 210° C., from about 160° C. to about 205° C., from about 160° C. to about 200° C., from about 160° C. to about 180° C., from about 180° C. to about 220° C., from about 180° C. to about 215° C., from about 180° C. to about 210° C., from about 180° C. to about 205° C., from about 180° C. to about 200° C., from about 200° C. to about 220° C., from about 200° C. to about 215° C., from about 200° C. to about 210° C., from about 200° C. to about 205° C., from about 205° C. to about 220° C., from about 205° C. to about 215° C., from about 205° C. to about 210° C., from about 210° C. to about 220° C., from about 215° C. to about 220° C., from about 215° C. to about 220° C., or at most about 50° C., at most about 60° C., at most about 70° C., at most about 80° C., at most about 90° C., at most about 100° C., at most about 120° C., at most about 140° C., at most about 160° C., at most about 180° C., at most about 200° C., at most about 205° C., at most about 210° C., at most about 215° C., at most about 220° C., or about 50° C., about 60° C., about 70° C., about 80° C., about 90° C., about 100° C., about 120° C., about 140° C., about 160° C., about 180° C., about 200° C., about 205° C., about 210° C., about 215° C., about 220° C., or any ranges or values therebetween.

The duration of the heat treatment may be in the range of at least about 10 minutes, at least about 15 minutes, at least about 35 minutes, at least about 1 hour, at least about 2 hours, at least about 3 hours, at least about 4 hours, at least about 5 hours, at least about 6 hours, at least about 7 hours, at least about 8 hours, at least about 24 hours, at least about 48 hours, at least about 72 hours, at least about 80 hours, or from about 10 minutes to about 80 hours, from about 10 minutes to about 72 hours, from about 10 minutes to about 48 hours, from about 10 minutes to about 24 hours, from about 10 minutes to about 8 hours, from about 10 minutes to about 7 hours, from about 10 minutes to about 6 hours, from about 10 minutes to about 5 hours, from about 10 minutes to about 4 hours, from about 10 minutes to about 3 hours, from about 10 minutes to about 2 hours, from about 10 minutes to about 1 hour, from about 10 minutes to about 35 minutes, from about 10 minutes to about 15 minutes, from about 15 minutes to about 80 hours, from about 15 minutes to about 72 hours, from about 15 minutes to about 48 hours, from about 15 minutes to about 24 hours, from about 15 minutes to about 8 hours, from about 15 minutes to about 7 hours, from about 15 minutes to about 6 hours, from about 15 minutes to about 5 hours, from about 15 minutes to about 4 hours, from about 15 minutes to about 3 hours, from about 15 minutes to about 2 hours, from about 15 minutes to about 1 hour, from about 15 minutes to about 35 minutes, from about 35 minutes to about 80 hours, from about 35 minutes to about 72 hours, from about 35 minutes to about 48 hours, from about 35 minutes to about 24 hours, from about 35 minutes to about 8 hours, from about 35 minutes to about 7 hours, from about 35 minutes to about 6 hours, from about 35 minutes to about 5 hours, from about 35 minutes to about 4 hours, from about 35 minutes to about 3 hours, from about 35 minutes to about 2 hours, from about 35 minutes to about 1 hour, from about 1 hour to about 80 hours, from about 1 hour to about 72 hours, from about 1 hour to about 48 hours, from about 1 hour to about 24 hours, from about 1 hour to about 8 hours, from about 1 hour to about 7 hours, from about 1 hour to about 6 hours, from about 1 hour to about 5 hours, from about 1 hour to about 4 hours, from about 1 hour to about 3 hours, from about 1 hour to about 2 hours, from about 2 hours to about 80 hours, from about 2 hours to about 72 hours, from about 2 hours to about 48 hours, from about 2 hours to about 24 hours, from about 2 hours to about 8 hours, from about 2 hours to about 7 hours, from about 2 hours to about 6 hours, from about 2 hours to about 5 hours, from about 2 hours to about 4 hours, from about 2 hours to about 3 hours, from about 3 hours to about 80 hours, from about 3 hours to about 72 hours, from about 3 hours to about 48 hours, from about 3 hours to about 24 hours, from about 3 hours to about 8 hours, from about 3 hours to about 7 hours, from about 3 hours to about 6 hours, from about 3 hours to about 5 hours, from about 3 hours to about 4 hours, from about 4 hours to about 80 hours, from about 4 hours to about 72 hours, from about 4 hours to about 48 hours, from about 4 hours to about 24 hours, from about 4 hours to about 8 hours, from about 4 hours to about 7 hours, from about 4 hours to about 6 hours, from about 4 hours to about 5 hours, from about 5 hours to about 80 hours, from about 5 hours to about 72 hours, from about 5 hours to about 48 hours, from about 5 hours to about 24 hours, from about 5 hours to about 8 hours, from about 5 hours to about 7 hours, from about 5 hours to about 6 hours, from about 6 hours to about 80 hours, from about 6 hours to about 72 hours, from about 6 hours to about 48 hours, from about 6 hours to about 24 hours, from about 6 hours to about 8 hours, from about 6 hours to about 7 hours, from about 7 hours to about 80 hours, from about 7 hours to about 72 hours, from about 7 hours to about 48 hours, from about 7 hours to about 24 hours, from about 7 hours to about 8 hours, from about 8 hours to about 80 hours, from about 8 hours to about 72 hours, from about 8 hours to about 48 hours, from about 8 hours to about 24 hours, from about 24 hours to about 80 hours, from about 24 hours to about 72 hours, from about 24 hours to about 48 hours, from about 48 hours to about 80 hours, from about 48 hours to about 72 hours, from about 72 hours to about 80 hours, or at most about 10 minutes, at most about 15 minutes about 35 minutes, at most about 1 hour, at most about 2 hours, at most about 3 hours, at most about 4 hours, at most about 5 hours, at most about 6 hours, at most about 7 hours, at most about 8 hours, at most about 24 hours, at most about 48 hours, at most about 72 hours, at most about 80 hours, or about 10 minutes, about 15 minutes, about 35 minutes, about 1 hour, about 2 hours, about 3 hours, about 4 hours, about 5 hours, about 6 hours, about 7 hours, about 8 hours, about 24 hours, about 48 hours, about 72 hours, about 80 hours, or any ranges or values therebetween.

In some embodiments, treating the fruit comprises hydrothermally treating the fruit to obtain the leaching solution. In some embodiments, the present disclosure discloses a method comprising hydrothermally treating the fruit at a temperature of at least about 100° C., at least about 120° C., at least about 140° C., at least about 160° C., at least about 180° C., at least about 200° C., at least about 220° C.; or from about 100° C. to about 220° C., from about 100° C. to about 200° C., from about 100° C. to about 180° C., from about 100° C. to about 160° C., from about 100° C. to about 140° C., from about 100° C. to about 120° C., from about 120° C. to about 220° C., from about 120° C. to about 200° C., from about 120° C. to about 180° C., from about 120° C. to about 160° C., from about 120° C. to about 140° C., from about 140° C. to about 220° C., from about 140° C. to about 200° C., from about 140° C. to about 180° C., from about 140° C. to about 160° C., from about 160° C. to about 220° C., from about 160° C. to about 200° C., from about 160° C. to about 180° C., from about 180° C. to about 220° C., from about 180° C. to about 200° C., from about 200° C. to about 220° C.; or at most about 100° C., at most about 120° C., at most about 140° C., at most about 160° C., at most about 180° C., at most about 200° C., at most about 220° C.; or about 100° C., about 120° C., about 140° C., about 160° C., about 180° C., about 200° C., about 220° C., or any ranges or values therebetween. In some preferred embodiments, the method disclosed comprises hydrothermally treating the fruit from about 120° C. to about 200° C. In some further preferred embodiments, the method disclosed comprises hydrothermally treating the fruit at about 200° C.

In further embodiments, the present disclosure discloses a method comprising hydrothermally treating the fruit for a duration of at least about 1 hour, at least about 2 hours, at least about 3 hours, at least about 4 hours, at least about 5 hours, at least about 6 hours, at least about 7 hours, at least about 8 hours; or from about 1 hour to about 8 hours, from about 1 hour to about 7 hours, from about 1 hour to about 6 hours, from about 1 hour to about 5 hours, from about 1 hour to about 4 hours, from about 1 hour to about 3 hours, from about 1 hour to about 2 hours, from about 2 hours to about 8 hours, from about 2 hours to about 7 hours, from about 2 hours to about 6 hours, from about 2 hours to about 5 hours, from about 2 hours to about 4 hours, from about 2 hours to about 3 hours, from about 3 hours to about 8 hours, from about 3 hours to about 7 hours, from about 3 hours to about 6 hours, from about 3 hours to about 5 hours, from about 3 hours to about 4 hours, from about 4 hours to about 8 hours, from about 4 hours to about 7 hours, from about 4 hours to about 6 hours, from about 4 hours to about 5 hours, from about 5 hours to about 8 hours, from about 5 hours to about 7 hours, from about 5 hours to about 6 hours, from about 6 hours to about 8 hours, from about 6 hours to about 7 hours, from about 7 hours to about 8 hours; or at most about 1 hour, at most about 2 hours, at most about 3 hours, at most about 4 hours, at most about 5 hours, at most about 6 hours, at most about 7 hours, at most about 8 hours; or about 1 hour, about 2 hours, about 3 hours, about 4 hours, about 5 hours, about 6 hours, about 7 hours, about 8 hours, or any ranges or values therebetween. In some preferred embodiments, the method disclosed comprises hydrothermally treating the fruit for about 4 hours.

Hence, the present disclosure provides a method comprising hydrothermally treating the fruit at a temperature from about 120° C. to about 200° C. The present disclosure also provides a method comprising hydrothermally treating the fruit for about 4 hours. The present disclosure further provides a method comprising hydrothermally treating the fruit at a temperature from about 120° C. to about 200° C., for about 4 hours.

In some embodiments, treating the fruit comprises hydrolysing the fruit to obtain the leaching solution. In some embodiments, the present disclosure discloses a method comprising hydrolysing the fruit at a temperature of at least about 30° C., at least about 40° C., at least about 50° C., at least about 60° C., at least about 70° C., at least about 80° C., at least about 90° C., at least about 100° C.; or from about 30° C. to about 100° C., from about 30° C. to about 90° C., from about 30° C. to about 80° C., from about 30° C. to about 70° C., from about 30° C. to about 60° C., from about 30° C. to about 50° C., from about 30° C. to about 40° C., from about 40° C. to about 100° C., from about 40° C. to about 90° C., from about 40° C. to about 80° C., from about 40° C. to about 70° C., from about 40° C. to about 60° C., from about 40° C. to about 50° C., from about 50° C. to about 100° C., from about 50° C. to about 90° C., from about 50° C. to about 80° C., from about 50° C. to about 70° C., from about 50° C. to about 60° C., from about 60° C. to about 100° C., from about 60° C. to about 90° C., from about 60° C. to about 80° C., from about 60° C. to about 70° C., from about 70° C. to about 100° C., from about 70° C. to about 90° C., from about 70° C. to about 80° C., from about 80° C. to about 100° C., from about 80° C. to about 90° C., from about 90° C. to about 100° C.; or at most about 30° C., at most about 40° C., at most about 50° C., at most about 60° C., at most about 70° C., at most about 80° C., at most about 90° C., at most about 100° C.; or about 30° C., about 40° C., about 50° C., about 60° C., about 70° C., about 80° C., about 90° C., about 100° C., or any ranges or values therebetween. In preferred embodiments, the disclosed method comprises hydrolysing the fruit from about 40° C. to about 100° C. In further preferred embodiments, the disclosed method comprises hydrolysing the fruit at about 90° C.

In other embodiments, the present disclosure discloses a method comprising hydrolysing the fruit for a duration of at least about 1 day, at least about 2 days, at least about 3 days, at least about 4 days, at least about 5 days; or from about 1 day to about 5 days, from about 1 day to about 4 days, from about 1 day to about 3 days, from about 1 day to about 2 days, from about 2 days to about 5 days, from about 2 days to about 4 days, from about 2 days to about 3 days, from about 3 days to about 5 days, from about 3 days to about 4 days, from about 4 days to about 5 days; or at most about 1 day, at most about 2 days, at most about 3 days, at most about 4 days, at most about 5 days; or about 1 day, about 2 days, about 3 days, about 4 days, about 5 days, or any ranges or values therebetween. In preferred embodiments, the disclosed method comprises hydrolysing the fruit for about 3 days.

The present disclosure hence discloses a method, comprising hydrolysing the fruit from about 40° C. to about 100° C. The present disclosure also discloses a method comprising hydrolysing the fruit at about 90° C. The present disclosure further discloses a method comprising hydrolysing the fruit for about 3 days. The present disclosure also discloses a method further comprising hydrolysing the fruit from about 40° C. to about 100° C., for about 3 days.

In some other embodiments, the heat treatment may be a microwave-assisted heat treatment. The temperature of the microwave-assisted heat treatment may be at least about 70° C., at least about 80° C., at least about 90° C., at least about 100° C., at least about 120° C., at least about 140° C., at least about 160° C., at least about 180° C., at least about 200° C., at least about 205° C., at least about 210° C., at least about 215° C., at least about 220° C.; or from about 70° C. to about 220° C., from about 70° C. to about 215° C., from about 70° C. to about 210° C., from about 70° C. to about 205° C., from about 70° C. to about 200° C., from about 70° C. to about 180° C., from about 70° C. to about 160° C., from about 70° C. to about 140° C., from about 70° C. to about 120° C., from about 70° C. to about 100° C., from about 70° C. to about 90° C., from about 70° C. to about 80° C., from about 80° C. to about 220° C., from about 80° C. to about 215° C., from about 80° C. to about 210° C., from about 80° C. to about 205° C., from about 80° C. to about 200° C., from about 80° C. to about 180° C., from about 80° C. to about 160° C., from about 80° C. to about 140° C., from about 80° C. to about 120° C., from about 80° C. to about 100° C., from about 80° C. to about 90° C., from about 90° C. to about 220° C., from about 90° C. to about 215° C., from about 90° C. to about 210° C., from about 90° C. to about 205° C., from about 90° C. to about 200° C., from about 90° C. to about 180° C., from about 90° C. to about 160° C., from about 90° C. to about 140° C., from about 90° C. to about 120° C., from about 90° C. to about 100° C., from about 100° C. to about 220° C., from about 100° C. to about 215° C., from about 100° C. to about 210° C., from about 100° C. to about 205° C., from about 100° C. to about 200° C., from about 100° C. to about 180° C., from about 100° C. to about 160° C., from about 100° C. to about 140° C., from about 100° C. to about 120° C., from about 120° C. to about 220° C., from about 120° C. to about 215° C., from about 120° C. to about 210° C., from about 120° C. to about 205° C., from about 120° C. to about 200° C., from about 120° C. to about 180° C., from about 120° C. to about 160° C., from about 120° C. to about 140° C., from about 140° C. to about 220° C., from about 140° C. to about 215° C., from about 140° C. to about 210° C., from about 140° C. to about 205° C., from about 140° C. to about 200° C., from about 140° C. to about 180° C., from about 140° C. to about 160° C., from about 160° C. to about 220° C., from about 160° C. to about 215° C., from about 160° C. to about 210° C., from about 160° C. to about 205° C., from about 160° C. to about 200° C., from about 160° C. to about 180° C., from about 180° C. to about 220° C., from about 180° C. to about 215° C., from about 180° C. to about 210° C., from about 180° C. to about 205° C., from about 180° C. to about 200° C., from about 200° C. to about 220° C., from about 200° C. to about 215° C., from about 200° C. to about 210° C., from about 200° C. to about 205° C., from about 205° C. to about 220° C., from about 205° C. to about 215° C., from about 205° C. to about 210° C., from about 210° C. to about 220° C., from about 210° C. to about 215° C., from about 215° C. to about 220° C.; or at most about 70° C., at most about 80° C., at most about 90° C., at most about 100° C., at most about 120° C., at most about 140° C., at most about 160° C., at most about 180° C., at most about 200° C., at most about 205° C., at most about 210° C., at most about 215° C., at most about 220° C.; or about 70° C., about 80° C., about 90° C., about 100° C., about 120° C., about 140° C., about 160° C., about 180° C., about 200° C., about 205° C., about 210° C., about 215° C., about 220° C., or any ranges or values therebetween.

The duration of the microwave-assisted heat treatment may be at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 60 minutes, at least about 70 minutes, at least about 80 minutes, at least about 90 minutes, or from about 5 minutes to about 90 minutes, from about 5 minutes to about 80 minutes, from about 5 minutes to about 70 minutes, from about 5 minutes to about 60 minutes, from about 5 minutes to about 55 minutes, from about 5 minutes to about 50 minutes, from about 5 minutes to about 45 minutes, from about 5 minutes to about 40 minutes, from about 5 minutes to about 35 minutes, from about 5 minutes to about 30 minutes, from about 5 minutes to about 25 minutes, from about 5 minutes to about 20 minutes, from about 5 minutes to about 15 minutes, from about 5 minutes to about 10 minutes, from about 10 minutes to about 90 minutes, from about 10 minutes to about 80 minutes, from about 10 minutes to about 70 minutes, from about 10 minutes to about 60 minutes, from about 10 minutes to about 55 minutes, from about 10 minutes to about 50 minutes, from about 10 minutes to about 45 minutes, from about 10 minutes to about 40 minutes, from about 10 minutes to about 35 minutes, from about 10 minutes to about 30 minutes, from about 10 minutes to about 25 minutes, from about 10 minutes to about 20 minutes, from about 10 minutes to about 15 minutes, from about 15 minutes to about 90 minutes, from about 15 minutes to about 80 minutes, from about 15 minutes to about 70 minutes, from about 15 minutes to about 60 minutes, from about 15 minutes to about 55 minutes, from about 15 minutes to about 50 minutes, from about 15 minutes to about 45 minutes, from about 15 minutes to about 40 minutes, from about 15 minutes to about 35 minutes, from about 15 minutes to about 30 minutes, from about 15 minutes to about 25 minutes, from about 15 minutes to about 20 minutes, from about 20 minutes to about 90 minutes, from about 20 minutes to about 80 minutes, from about 20 minutes to about 70 minutes, from about 20 minutes to about 60 minutes, from about 20 minutes to about 55 minutes, from about 20 minutes to about 50 minutes, from about 20 minutes to about 45 minutes, from about 20 minutes to about 40 minutes, from about 20 minutes to about 35 minutes, from about 20 minutes to about 30 minutes, from about 20 minutes to about 25 minutes, from about 25 minutes to about 90 minutes, from about 25 minutes to about 80 minutes, from about 25 minutes to about 70 minutes, from about 25 minutes to about 60 minutes, from about 25 minutes to about 55 minutes, from about 25 minutes to about 50 minutes, from about 25 minutes to about 45 minutes, from about 25 minutes to about 40 minutes, from about 25 minutes to about 35 minutes, from about 25 minutes to about 30 minutes, from about 30 minutes to about 90 minutes, from about 30 minutes to about 80 minutes, from about 30 minutes to about 70 minutes, from about 30 minutes to about 60 minutes, from about 30 minutes to about 55 minutes, from about 30 minutes to about 50 minutes, from about 30 minutes to about 45 minutes, from about 30 minutes to about 40 minutes, from about 30 minutes to about 35 minutes, from about 35 minutes to about 90 minutes, from about 35 minutes to about 80 minutes, from about 35 minutes to about 70 minutes, from about 35 minutes to about 60 minutes, from about 35 minutes to about 55 minutes, from about 35 minutes to about 50 minutes, from about 35 minutes to about 45 minutes, from about 35 minutes to about 40 minutes, from about 40 minutes to about 90 minutes, from about 40 minutes to about 80 minutes, from about 40 minutes to about 70 minutes, from about 40 minutes to about 60 minutes, from about 40 minutes to about 55 minutes, from about 40 minutes to about 50 minutes, from about 40 minutes to about 45 minutes, from about 45 minutes to about 90 minutes, from about 45 minutes to about 80 minutes, from about 45 minutes to about 70 minutes, from about 45 minutes to about 60 minutes, from about 45 minutes to about 55 minutes, from about 45 minutes to about 50 minutes, from about 50 minutes to about 90 minutes, from about 50 minutes to about 80 minutes, from about 50 minutes to about 70 minutes, from about 50 minutes to about 60 minutes, from about 50 minutes to about 55 minutes, from about 55 minutes to about 90 minutes, from about 55 minutes to about 80 minutes, from about 55 minutes to about 70 minutes, from about 55 minutes to about 60 minutes, from about 60 minutes to about 90 minutes, from about 60 minutes to about 80 minutes, from about 60 minutes to about 70 minutes, from about 70 minutes to about 90 minutes, from about 70 minutes to about 80 minutes, from about 80 minutes to about 90 minutes, or at most about 5 minutes, at most about 10 minutes, at most about 15 minutes, at most about 20 minutes, at most about 25 minutes, at most about 30 minutes, at most about 35 minutes, at most about 40 minutes, at most about 45 minutes, at most about 50 minutes, at most about 55 minutes, at most about 60 minutes, at most about 70 minutes, at most about 80 minutes, at most about 90 minutes, or about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes, about 70 minutes, about 80 minutes, about 90 minutes, or any values or ranges therebetween.

In some other embodiments, the present disclosure discloses a method comprising microwave-assisted heat treating the fruit, involving at least a ramping step of raising the temperature of the mixture in the vessel to the reaction temperature; a holding step wherein the mixture is stirred and held at a certain reaction temperature; and a cooling step wherein the mixture is left to cool to room temperature. The ramping step may take as short as 1 minute, or as long as 10 minutes depending on the properties of the mixture and its propensity for absorbing microwave radiation. The holding step may comprise any duration required for a general reaction or in this present disclosure, any duration required to complete the microwave-assisted heat treating of the fruit. A reaction profile in a microwave-assisted reaction may consist of multiple holding and ramping steps as required by the reaction needs or in order to reach a high temperature. The cooling step may take from anywhere between 2 minutes to 20 minutes depending on the size of the reaction vessel and the heat capacity of the mixture inside the vessel. As such, the ramping and cooling duration may sometimes be set by the microwave equipment, or may be arbitrary depending on the power output by the microwave equipment. The reaction duration may be considered to be the sum of all ramping and/or holding and/or cooling steps in the reaction profile.

In some embodiments, the disclosed method may comprise a ramping and/or cooling step of at least about 2 minutes, at least about 4 minutes, at least about 6 minutes, at least about 8 minutes, at least about 10 minutes; or from about 2 minutes to about 10 minutes, from about 2 minutes to about 8 minutes, from about 2 minutes to about 6 minutes, from about 2 minutes to about 4 minutes, from about 4 minutes to about 10 minutes, from about 4 minutes to about 8 minutes, from about 4 minutes to about 6 minutes, from about 6 minutes to about 10 minutes, from about 6 minutes to about 8 minutes, from about 8 minutes to about 10 minutes; or at most about 2 minutes, at most about 4 minutes, at most about 6 minutes, at most about 8 minutes, at most about 10 minutes; or about 2 minutes, about 4 minutes, about 6 minutes, about 8 minutes, about 10 minutes, or any ranges or values therebetween.

In other embodiments the disclosed method may comprise a holding step of at least about 1 minute, at least about 5 minutes, at least about 10 minutes, at least about 15 minutes, at least about 20 minutes, at least about 25 minutes, at least about 30 minutes at least about 40 minutes; or from about 1 minute to about 40 minutes, from about 1 minute to about 30 minutes, from about 1 minute to about 25 minutes, from about 1 minute to about 20 minutes, from about 1 minute to about 15 minutes, from about 1 minute to about 10 minutes, from about 1 minute to about 5 minutes, from about 5 minutes to about 40 minutes, from about 5 minutes to about 30 minutes, from about 5 minutes to about 25 minutes, from about 5 minutes to about 20 minutes, from about 5 minutes to about 15 minutes, from about 5 minutes to about 10 minutes, from about 10 minutes to about 40 minutes, from about 10 minutes to about 30 minutes, from about 10 minutes to about 25 minutes, from about 10 minutes to about 20 minutes, from about 10 minutes to about 15 minutes, from about 15 minutes to about 40 minutes, from about 15 minutes to about 30 minutes, from about 15 minutes to about 25 minutes, from about 15 minutes to about 20 minutes, from about 20 minutes to about 40 minutes, from about 20 minutes to about 30 minutes, from about 20 minutes to about 25 minutes, from about 25 minutes to about 40 minutes, from about 25 minutes to about 30 minutes, from about 30 minutes to about 40 minutes; or at most about 1 minute, at most about 5 minutes, at most about 10 minutes, at most about 15 minutes, at most about 20 minutes, at most about 25 minutes, at most about 30 minutes, at most about 40 minutes; or about 1 minute, about 5 minutes, about 10 minutes, about 15 minutes, about 20 minutes, about 25 minutes, about 30 minutes, about 40 minutes, or any ranges or values therebetween.

In some other embodiments, the disclosed method may comprise microwave-assisted heat treating the fruit for a reaction duration of at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 60 minutes; or from about 10 minutes to about 60 minutes, from about 10 minutes to about 50 minutes, from about 10 minutes to about 45 minutes, from about 10 minutes to about 40 minutes, from about 10 minutes to about 35 minutes, from about 10 minutes to about 30 minutes, from about 10 minutes to about 25 minutes, from about 10 minutes to about 20 minutes, from about 10 minutes to about 15 minutes, from about 15 minutes to about 60 minutes, from about 15 minutes to about 50 minutes, from about 15 minutes to about 45 minutes, from about 15 minutes to about 40 minutes, from about 15 minutes to about 35 minutes, from about 15 minutes to about 30 minutes, from about 15 minutes to about 25 minutes, from about 15 minutes to about 20 minutes, from about 20 minutes to about 60 minutes, from about 20 minutes to about 50 minutes, from about 20 minutes to about 45 minutes, from about 20 minutes to about 40 minutes, from about 20 minutes to about 35 minutes, from about 20 minutes to about 30 minutes, from about 20 minutes to about 25 minutes, from about 25 minutes to about 60 minutes, from about 25 minutes to about 50 minutes, from about 25 minutes to about 45 minutes, from about 25 minutes to about 40 minutes, from about 25 minutes to about 35 minutes, from about 25 minutes to about 30 minutes, from about 30 minutes to about 60 minutes, from about 30 minutes to about 50 minutes, from about 30 minutes to about 45 minutes, from about 30 minutes to about 40 minutes, from about 30 minutes to about 35 minutes, from about 35 minutes to about 60 minutes, from about 35 minutes to about 50 minutes, from about 35 minutes to about 45 minutes, from about 35 minutes to about 40 minutes, from about 40 minutes to about 60 minutes, from about 40 minutes to about 50 minutes, from about 40 minutes to about 45 minutes, from about 45 minutes to about 60 minutes, from about 45 minutes to about 50 minutes, from about 50 minutes to about 60 minutes; or at most about 10 minutes, at most about 15 minutes, at most about 20 minutes, at most about 25 minutes, at most about 30 minutes, at most about 35 minutes, at most about 40 minutes, at most about 45 minutes, at most about 50 minutes, at most about 60 minutes; or about 10 minutes, about 15 minutes, about 20 minutes, about 25 minutes, about 30 minutes, about 35 minutes, about 40 minutes, about 45 minutes, about 50 minutes, about 60 minutes, or any ranges or values therebetween.

The present disclosure hence provides a method comprising microwave-assisted heat treating the fruit at about 180° C. for about 35 minutes.

The leaching solution obtained (treated extract), whether by fermentation or heat treatment, may comprise organic acids at about 0.5 wt % to 60 wt % of the solution, reducing organic compounds at about 0.1 wt % to 60 wt % of the solution and water at about 20 wt % to 99.9 wt % of the solution. Organic acids may contain one or a mixture of any of the following: lactic acid, glycolic acid, citric acid, malic acid, tartaric acid, succinic acid, benzoic acid, ascorbic acid, quininic acid or combinations and mixtures thereof. Organic reducing compounds may contain one or a mixture of any of the following: ascorbic acid, lactic acid, citric acid, phenolic compounds, flavonoids, reducing sugars, or combinations and mixtures thereof.

In some embodiments, the treated extract comprises organic acids by wt % of the solution, at least about 0.1 wt %, at least about 0.5 wt %, at least about 1 wt %, at least about 5 wt %, at least about 10 wt %, at least about 20 wt %, at least about 30 wt %, at least about 40 wt %, at least about 50 wt %, at least about 60 wt %, at least about 70 wt %, at least about 80 wt %, at least about 90 wt %; or from about 0.1 wt % to about 90 wt %, from about 0.1 wt % to about 80 wt %, from about 0.1 wt % to about 70 wt %, from about 0.1 wt % to about 60 wt %, from about 0.1 wt % to about 50 wt %, from about 0.1 wt % to about 40 wt %, from about 0.1 wt % to about 30 wt %, from about 0.1 wt % to about 20 wt %, from about 0.1 wt % to about 10 wt %, from about 0.1 wt % to about 5 wt %, from about 0.1 wt % to about 1 wt %, from about 0.1 wt % to about 0.5 wt %, from about 0.5 wt % to about 90 wt %, from about 0.5 wt % to about 80 wt %, from about 0.5 wt % to about 70 wt %, from about 0.5 wt % to about 60 wt %, from about 0.5 wt % to about 50 wt %, from about 0.5 wt % to about 40 wt %, from about 0.5 wt % to about 30 wt %, from about 0.5 wt % to about 20 wt %, from about 0.5 wt % to about 10 wt %, from about 0.5 wt % to about 5 wt %, from about 0.5 wt % to about 1 wt %, from about 1 wt % to about 90 wt %, from about 1 wt % to about 80 wt %, from about 1 wt % to about 70 wt %, from about 1 wt % to about 60 wt %, from about 1 wt % to about 50 wt %, from about 1 wt % to about 40 wt %, from about 1 wt % to about 30 wt %, from about 1 wt % to about 20 wt %, from about 1 wt % to about 10 wt %, from about 1 wt % to about 5 wt %, from about 5 wt % to about 90 wt %, from about 5 wt % to about 80 wt %, from about 5 wt % to about 70 wt %, from about 5 wt % to about 60 wt %, from about 5 wt % to about 50 wt %, from about 5 wt % to about 40 wt %, from about 5 wt % to about 30 wt %, from about 5 wt % to about 20 wt %, from about 5 wt % to about 10 wt %, from about 10 wt % to about 90 wt %, from about 10 wt % to about 80 wt %, from about 10 wt % to about 70 wt %, from about 10 wt % to about 60 wt %, from about 10 wt % to about 50 wt %, from about 10 wt % to about 40 wt %, from about 10 wt % to about 30 wt %, from about 10 wt % to about 20 wt %, from about 20 wt % to about 90 wt %, from about 20 wt % to about 80 wt %, from about 20 wt % to about 70 wt %, from about 20 wt % to about 60 wt %, from about 20 wt % to about 50 wt %, from about 20 wt % to about 40 wt %, from about 20 wt % to about 30 wt %, from about 30 wt % to about 90 wt %, from about 30 wt % to about 80 wt %, from about 30 wt % to about 70 wt %, from about 30 wt % to about 60 wt %, from about 30 wt % to about 50 wt %, from about 30 wt % to about 40 wt %, from about 40 wt % to about 90 wt %, from about 40 wt % to about 80 wt %, from about 40 wt % to about 70 wt %, from about 40 wt % to about 60 wt %, from about 40 wt % to about 50 wt %, from about 50 wt % to about 90 wt %, from about 50 wt % to about 80 wt %, from about 50 wt % to about 70 wt %, from about 50 wt % to about 60 wt %, from about 60 wt % to about 90 wt %, from about 60 wt % to about 80 wt %, from about 60 wt % to about 70 wt %, from about 70 wt % to about 90 wt %, from about 70 wt % to about 80 wt %, from about 80 wt % to about 90 wt %; or at most about 0.1 wt %, at most about 0.5 wt %, at most about 1 wt %, at most about 5 wt %, at most about 10 wt %, at most about 20 wt %, at most about 30 wt %, at most about 40 wt %, at most about 50 wt %, at most about 60 wt %, at most about 70 wt %, at most about 80 wt %, at most about 90 wt %; or about 0.1 wt %, about 0.5 wt %, about 1 wt %, about 5 wt %, about 10 wt %, about 20 wt %, about 30 wt %, about 40 wt %, about 50 wt %, about 60 wt %, about 70 wt %, about 80 wt %, about 90 wt %, or any ranges or values therebetween.

In some embodiments, the treated extract comprises reducing organic compounds by wt % of the solution, at least about 0.1 wt %, at least about 0.5 wt %, at least about 1 wt %, at least about 5 wt %, at least about 10 wt %, at least about 20 wt %, at least about 30 wt %, at least about 40 wt %, at least about 50 wt %, at least about 60 wt %, at least about 70 wt %, at least about 80 wt %, at least about 90 wt %; or from about 0.1 wt % to about 90 wt %, from about 0.1 wt % to about 80 wt %, from about 0.1 wt % to about 70 wt %, from about 0.1 wt % to about 60 wt %, from about 0.1 wt % to about 50 wt %, from about 0.1 wt % to about 40 wt %, from about 0.1 wt % to about 30 wt %, from about 0.1 wt % to about 20 wt %, from about 0.1 wt % to about 10 wt %, from about 0.1 wt % to about 5 wt %, from about 0.1 wt % to about 1 wt %, from about 0.1 wt % to about 0.5 wt %, from about 0.5 wt % to about 90 wt %, from about 0.5 wt % to about 80 wt %, from about 0.5 wt % to about 70 wt %, from about 0.5 wt % to about 60 wt %, from about 0.5 wt % to about 50 wt %, from about 0.5 wt % to about 40 wt %, from about 0.5 wt % to about 30 wt %, from about 0.5 wt % to about 20 wt %, from about 0.5 wt % to about 10 wt %, from about 0.5 wt % to about 5 wt %, from about 0.5 wt % to about 1 wt %, from about 1 wt % to about 90 wt %, from about 1 wt % to about 80 wt %, from about 1 wt % to about 70 wt %, from about 1 wt % to about 60 wt %, from about 1 wt % to about 50 wt %, from about 1 wt % to about 40 wt %, from about 1 wt % to about 30 wt %, from about 1 wt % to about 20 wt %, from about 1 wt % to about 10 wt %, from about 1 wt % to about 5 wt %, from about 5 wt % to about 90 wt %, from about 5 wt % to about 80 wt %, from about 5 wt % to about 70 wt %, from about 5 wt % to about 60 wt %, from about 5 wt % to about 50 wt %, from about 5 wt % to about 40 wt %, from about 5 wt % to about 30 wt %, from about 5 wt % to about 20 wt %, from about 5 wt % to about 10 wt %, from about 10 wt % to about 90 wt %, from about 10 wt % to about 80 wt %, from about 10 wt % to about 70 wt %, from about 10 wt % to about 60 wt %, from about 10 wt % to about 50 wt %, from about 10 wt % to about 40 wt %, from about 10 wt % to about 30 wt %, from about 10 wt % to about 20 wt %, from about 20 wt % to about 90 wt %, from about 20 wt % to about 80 wt %, from about 20 wt % to about 70 wt %, from about 20 wt % to about 60 wt %, from about 20 wt % to about 50 wt %, from about 20 wt % to about 40 wt %, from about 20 wt % to about 30 wt %, from about 30 wt % to about 90 wt %, from about 30 wt % to about 80 wt %, from about 30 wt % to about 70 wt %, from about 30 wt % to about 60 wt %, from about 30 wt % to about 50 wt %, from about 30 wt % to about 40 wt %, from about 40 wt % to about 90 wt %, from about 40 wt % to about 80 wt %, from about 40 wt % to about 70 wt %, from about 40 wt % to about 60 wt %, from about 40 wt % to about 50 wt %, from about 50 wt % to about 90 wt %, from about 50 wt % to about 80 wt %, from about 50 wt % to about 70 wt %, from about 50 wt % to about 60 wt %, from about 60 wt % to about 90 wt %, from about 60 wt % to about 80 wt %, from about 60 wt % to about 70 wt %, from about 70 wt % to about 90 wt %, from about 70 wt % to about 80 wt %, from about 80 wt % to about 90 wt %; or at most about 0.1 wt %, at most about 0.5 wt %, at most about 1 wt %, at most about 5 wt %, at most about 10 wt %, at most about 20 wt %, at most about 30 wt %, at most about 40 wt %, at most about 50 wt %, at most about 60 wt %, at most about 70 wt %, at most about 80 wt %, at most about 90 wt %; or about 0.1 wt %, about 0.5 wt %, about 1 wt %, about 5 wt %, about 10 wt %, about 20 wt %, about 30 wt %, about 40 wt %, about 50 wt %, about 60 wt %, about 70 wt %, about 80 wt %, about 90 wt %, or any ranges or values therebetween.

In some other embodiments, the treated extract comprises water by wt % of the solution, at least about 1 wt %, at least about 5 wt %, at least about 10 wt %, at least about 20 wt %, at least about 40 wt %, at least about 60 wt %, at least about 80 wt %, at least about 90 wt %, at least about 99.9 wt %; or from about 1 wt % to about 99.9 wt %, from about 1 wt % to about 90 wt %, from about 1 wt % to about 80 wt %, from about 1 wt % to about 60 wt %, from about 1 wt % to about 40 wt %, from about 1 wt % to about 20 wt %, from about 1 wt % to about 10 wt %, from about 1 wt % to about 5 wt %, from about 5 wt % to about 99.9 wt %, from about 5 wt % to about 90 wt %, from about 5 wt % to about 80 wt %, from about 5 wt % to about 60 wt %, from about 5 wt % to about 40 wt %, from about 5 wt % to about 20 wt %, from about 5 wt % to about 10 wt %, from about 10 wt % to about 99.9 wt %, from about 10 wt % to about 90 wt %, from about 10 wt % to about 80 wt %, from about 10 wt % to about 60 wt %, from about 10 wt % to about 40 wt %, from about 10 wt % to about 20 wt %, from about 20 wt % to about 99.9 wt %, from about 20 wt % to about 90 wt %, from about 20 wt % to about 80 wt %, from about 20 wt % to about 60 wt %, from about 20 wt % to about 40 wt %, from about 40 wt % to about 99.9 wt %, from about 40 wt % to about 90 wt %, from about 40 wt % to about 80 wt %, from about 40 wt % to about 60 wt %, from about 60 wt % to about 99.9 wt %, from about 60 wt % to about 90 wt %, from about 60 wt % to about 80 wt %, from about 80 wt % to about 99.9 wt %, from about 80 wt % to about 90 wt %, from about 90 wt % to about 99.9 wt %; or at most about 1 wt %, at most about 5 wt %, at most about 10 wt %, at most about 20 wt %, at most about 40 wt %, at most about 60 wt %, at most about 80 wt %, at most about 90 wt %, at most about 99.9 wt %; or about 1 wt %, about 5 wt %, about 10 wt %, about 20 wt %, about 40 wt %, about 60 wt %, about 80 wt %, about 90 wt %, about 99.9 wt %, or any ranges or values therebetween.

As mentioned above, the treatment disclosed results in the conversion of the saccharides and other polymeric compounds in agricultural waste, particularly fruit waste into various acid-containing components. Hence, the leaching solution formed from treatment is usually slightly acidic. The initial pH of the leaching solution without any additive may range from about 2 to about 6, or about 3 to about 5. As mentioned earlier however, a small amount of acid may be added to the leaching solution to protonate the organic acids in the leaching solution.

In an embodiment, the method further comprises the step of:
(iia) before step (iii), adding an acid to the leaching solution of step (ii) to obtain an acidified leaching solution, and adding the crushed battery to the acidified leaching solution thereby obtaining a leachate comprising metal ions.

The acid added to the leaching solution of step (ii) to obtain an acidified leaching solution may be added in a concentration of at least about 0.02 M, at least about 0.04 M, at least about 0.08 M, at least about 0.16 M, at least about 0.2 M, at least about 0.24 M, at least about 0.25 M, at least about 0.28 M, at least about 0.3 M; or at most about 0.02 M, at most about 0.04 M, at most about 0.08 M, at most about 0.12 M, at most about 0.16 M, at most about 0.2 M, at most about 0.24 M, at most about 0.25 M, at most about 0.28 M, at most about 0.3 M; or may be added in a concentration from 0 M to about 0.3 M, from 0 M to about 0.28 M, from 0 M to about 0.25 M, from 0 M to about 0.24 M, from 0 M to about 0.2 M, from 0 M to about 0.16 M, from 0 M to about 0.12 M, from 0 M to about 0.08 M, from 0 M to about 0.04 M, from 0 M to about 0.02 M, from 0.02 M to about 0.3 M, from 0.02 M to about 0.3 M, from 0.02 M to about 0.28 M, from 0.02 M to about 0.25 M, from 0.02 M to about 0.24 M, from 0.02 M to about 0.2 M, from 0.02 M to about 0.16 M, from 0.02 M to about 0.08 M, from 0.02 M to about 0.04 M, about 0.04 M to about 0.3 M, from about 0.04 M to about 0.28 M, from about 0.04 M to about 0.25 M, from about 0.04 M to about 0.24 M, from about 0.04 M to about 0.25 M, from about 0.04 M to about 0.2 M, from about 0.04 M to about 0.16 M, from about 0.04 M to about 0.12 M, from about 0.04 M to about 0.08 M, from about 0.08 M to about 0.3 M, from about 0.08 M to about 0.28 M, from about 0.08 M to about 0.25 M, from about 0.08 M to about 0.24 M, from about 0.08 M to about 0.2 M, from about 0.08 M to about 0.16 M, from about 0.08 M to about 0.12 M, from about 0.12 M to about 0.3 M, from about 0.12 M to about 0.28 M, from about 0.12 M to about 0.25 M, from about 0.12 M to about 0.24 M, from about 0.12 M to about 0.2 M, from about 0.12 M to about 0.16 M, from about 0.16 M to about 0.3 M, from about 0.16 M to about 0.28 M, from about 0.16 M to about 0.25 M, from about 0.16 M to about 0.24 M, from about 0.16 M to about 0.2 M, from about 0.2 M to about 0.3 M, from about 0.2 M to about 0.28 M, from about 0.2 M to about 0.25 M, from about 0.2 M to about 0.24 M, from about 0.24 M to about 0.3 M, from about 0.24 M to about 0.28 M, from about 0.24 M to about 0.25 M, from about 0.25 M to about 0.3 M, from about 0.25 M to about 0.28 M, from about 0.28 M to about 0.3 M; or about 0.02 M, about 0.04 M, about 0.08 M, about 0.12 M, about 0.16 M, about 0.2 M, about 0.24 M, about 0.25 M, about 0.28 M, about 0.3 M or any ranges or values therebetween. In a preferred embodiment, the concentration of acid added is about 0.04 M to about 0.25 M. The present disclosure hence discloses a method wherein the concentration of acid added is about 0.04 M to about 0.3 M.

The pH of the acidified leaching solution may be in the range of at least about 0.4, at least about 0.5, at least about 0.55, at least about 0.66, at least about 0.68, at least about 0.78, at least about 0.8, at least about 0.94, at least about 1, at least about 1.12, at least about 1.2, at least about 1.4, at least about 1.5, at least about 1.52, at least about 1.6, at least about 1.8, at least about 2, at least about 2.2, at least about 2.35, at least about 2.5, at least about 2.53, at least about 2.8, or from about 0.4 to about 2.8, from about 0.4 to about 2.53, from about 0.4 to about 2.5, from about 0.4 to about 2.35, from about 0.4 to about 2.2, from about 0.4 to about 2, from about 0.4 to about 1.8, from about 0.4 to about 1.6, from about 0.4 to about 1.52, from about 0.4 to about 1.5, from about 0.4 to about 1.4, from about 0.4 to about 1.2, from about 0.4 to about 1.12, from about 0.4 to about 1, from about 0.4 to about 0.94, from about 0.4 to about 0.8, from about 0.4 to about 0.78, from about 0.4 to about 0.68, from about 0.4 to about 0.66, from about 0.4 to about 0.55, from about 0.4 to about 0.5, from about 0.5 to about 2.8, from about 0.5 to about 2.53, from about 0.5 to about 2.5, from about 0.5 to about 2.35, from about 0.5 to about 2.2, from about 0.5 to about 2, from about 0.5 to about 1.8, from about 0.5 to about 1.6, from about 0.5 to about 1.52, from about 0.5 to about 1.5, from about 0.5 to about 1.4, from about 0.5 to about 1.2, from about 0.5 to about 1.12, from about 0.5 to about 1, from about 0.5 to about 0.94, from about 0.5 to about 0.8, from about 0.5 to about 0.78, from about 0.5 to about 0.68, from about 0.5 to about 0.66, from about 0.5 to about 0.55, from about 0.55 to about 2.8, from about 0.55 to about 2.53, from about 0.55 to about 2.5, from about 0.55 to about 2.35, from about 0.55 to about 2.2, from about 0.55 to about 2, from about 0.55 to about 1.8, from about 0.55 to about 1.6, from about 0.55 to about 1.52, from about 0.55 to about 1.5, from about 0.55 to about 1.4, from about 0.55 to about 1.2, from about 0.55 to about 1.12, from about 0.55 to about 1, from about 0.55 to about 0.94, from about 0.55 to about 0.8, from about 0.55 to about 0.78, from about 0.55 to about 0.68, from about 0.55 to about 0.66, from about 0.66 to about 2.8, from about 0.66 to about 2.53, from about 0.66 to about 2.5, from about 0.66 to about 2.35, from about 0.66 to about 2.2, from about 0.66 to about 2, from about 0.66 to about 1.8, from about 0.66 to about 1.6, from about 0.66 to about 1.52, from about 0.66 to about 1.5, from about 0.66 to about 1.4, from about 0.66 to about 1.12, from about 0.66 to about 1, from about 0.66 to about 0.94, from about 0.66 to about 0.8, from about 0.66 to about 0.78, from about 0.66 to about 0.68, from about 0.68 to about 2.8, from about 0.68 to about 2.53, from about 0.68 to about 2.5, from about 0.68 to about 2.35, from about 0.68 to about 2.2, from about 0.68 to about 2, from about 0.68 to about 1.8, from about 0.68 to about 1.6, from about 0.68 to about 1.52, from about 0.68 to about 1.5, from about 0.68 to about 1.4, from about 0.68 to about 1.2, from about 0.68 to about 1.12, from about 0.68 to about 1, from about 0.68 to about 0.94, from about 0.68 to about 0.8, from about 0.68 to about 0.78, from about 0.78 to about 2.8, from about 0.78 to about 2.53, from about 0.78 to about 2.5, from about 0.78 to about 2.35, from about 0.78 to about 2.2, from about 0.78 to about 2, from about 0.78 to about 1.8, from about 0.78 to about 1.6, from about 0.78 to about 1.52, from about 0.78 to about 1.5, from about 0.78 to about 1.4, from about 0.78 to about 1.2, from about 0.78 to about 1.12, from about 0.78 to about 1, from about 0.78 to about 0.94, from about 0.78 to about 0.8, from about 0.8 to about 2.8, from about 0.8 to about 2.53, from about 0.8 to about 2.5, from about 0.8 to about 2.35, from about 0.8 to about 2.2, from about 0.8 to about 2, from about 0.8 to about 1.8, from about 0.8 to about 1.6, from about 0.8 to about 1.52, from about 0.8 to about 1.5, from about 0.8 to about 1.4, from about 0.8 to about 1.2, from about 0.8 to about 1.12, from about 0.8 to about 1, from about 0.8 to about 0.94, from about 0.94 to about 2.8, from about 0.94 to about 2.53, from about 0.94 to about 2.5, from about 0.94 to about 2.35, from about 0.94 to about 2.2, from about 0.94 to about 2, from about 0.94 to about 1.8, from about 0.94 to about 1.6, from about 0.94 to about 1.52, from about 0.94 to about 1.5, from about 0.94 to about 1.4, from about 0.94 to about 1.2, from about 0.94 to about 1.12, from about 0.94 to about 1, from about 1 to about 2.8, from about 1 to about 2.53, from about 1 to about 2.5, from about 1 to about 2.35, from about 1 to about 2.2, from about 1 to about 2, from about 1 to about 1.8, from about 1 to about 1.6, from about 1 to about 1.52, from about 1 to about 1.5, from about 1 to about 1.4, from about 1 to about 1.2, from about 1 to about 1.12, from about 1.12 to about 2.8, from about 1.12 to about 2.53, from about 1.12 to about 2.5, from about 1.12 to about 2.35, from about 1.12 to about 2.2, from about 1.12 to about 2, from about 1.12 to about 1.8, from about 1.12 to about 1.6, from about 1.12 to about 1.52, from about 1.12 to about 1.5, from about 1.12 to about 1.4, from about 1.12 to about 1.2, from about 1.2 to about 2.8, from about 1.2 to about 2.53, from about 1.2 to about 2.5, from about 1.2 to about 2.35, from about 1.2 to about 2.2, from about 1.2 to about 2, from about 1.2 to about 1.8, from about 1.2 to about 1.6, from about 1.2 to about 1.52, from about 1.2 to about 1.5, from about 1.2 to about 1.4, from about 1.4 to about 2.8, from about 1.4 to about 2.53, from about 1.4 to about 2.5, from about 1.4 to about 2.35, from about 1.4 to about 2.2, from about 1.4 to about 2, from about 1.4 to about 1.8, from about 1.4 to about 1.6, from about 1.4 to about 1.52, from about 1.4 to about 1.5, from about 1.5 to about 2.8, from about 1.5 to about 2.53, from about 1.5 to about 2.5, from about 1.5 to about 2.35, from about 1.5 to about 2.2, from about 1.5 to about 2, from about 1.5 to about 1.8, from about 1.5 to about 1.6, from about 1.5 to about 1.52, from about 1.52 to about 2.8, from about 1.52 to about 2.53, from about 1.52 to about 2.5, from about 1.52 to about 2.35, from about 1.52 to about 2.2, from about 1.52 to about 2, from about 1.52 to about 1.8, from about 1.52 to about 1.6, from about 1.6 to about 2.8, from about 1.6 to about 2.53, from about 1.6 to about 2.5, from about 1.6 to about 2.35, from about 1.6 to about 2.2, from about 1.6 to about 2, from about 1.6 to about 1.8, from about 1.8 to about 2.8, from about 1.8 to about 2.53, from about 1.8 to about 2.5, from about 1.8 to about 2.35, from about 1.8 to about 2.2, from about 1.8 to about 2, from about 2 to about 2.5, from about 2 to about 2.53, from about 2 to about 2.5, from about 2 to about 2.35, from about 2 to about 2.2, from about 2.2 to about 2.8, from about 2.2 to about 2.53, from about 2.2 to about 2.5, from about 2.2 to about 2.35, from about 2.35 to about 2.8, from about 2.35 to about 2.53, from about 2.35 to about 2.5, from about 2.5 to about 2.8, from about 2.5 to about 2.53, from about 2.53 to about 2.8; or at most about 0.4, at most about 0.5, at most about 0.55, at most about 0.66, at most about 0.68, at most about 0.78, at most about 0.8, at most about 0.94, at most about 1, at most about 1.12, at most about 1.2, at most about 1.4, at most about 1.5, at most about 1.52, at most about 1.6, at most about 1.8, at most about 2, at most about 2.2, at most about 2.35, at most about 2.5, at most about 2.53, at most about 2.8; or about 0.4, about 0.5, about 0.55, about 0.66, about 0.68, about 0.78, about 0.8, about 0.94, about 1, about 1.12, about 1.2, about 1.4, about 1.5, about 1.52, about 1.6, about 1.8, about 2, about 2.2, about 2.35, about 2.5, about 2.53, about 2.8, or any ranges or values therebetween. In a preferred embodiment, the pH of the acidified leaching solution is from about 0.4 to about 2.2.

The acid may be selected from the group consisting of hydrochloric acid, nitric acid, phosphoric acid, sulfuric acid, citric acid, acetic acid, tartaric acid, maleic acid, oxalic acid, L-ascorbic acid, succinic acid, quininic acid, isocitric acid, tannic acid, caffeic acid, lactic acid, formic acid, uric acid, barbituric acid, benzenesulfonic acid, benzoic acid, bromoacetic acid, chloroacetic acid, fumaric acid, gallic acid, methane sulfonic acid, phthalic acid, propionic acid, salicylic acid, sorbic acid, p-toluene sulfonic acid, fluoroantimonic acid, erucic acid, lauric acid, butyric acid, and mixtures thereof.

In other embodiments, the pH of the leaching solution after leaching (i.e., the leachate obtained), may range from about 3 to about 8. The moderate pH results in less base needed to neutralise the leachate. Alternatively, strong bases may not even be needed to treat the waste by-products from the leaching process, which leads to even more cost savings. In some embodiments, the pH of the leaching solution after leaching may be at least about 2.8, at least about 3, at least about 3.7, at least about 4, at least about 4.2, at least about 5, at least about 5.6, at least about 5.7, at least about 6, at least about 7, at least about 7.4, at least about 8; or from about 2.8 to about 8, from about 2.8 to about 7.4, from about 2.8 to about 7, from about 2.8 to about 6, from about 2.8 to about 5.7, from about 2.8 to about 5.6, from about 2.8 to about 5, from about 2.8 to about 4.2, from about 2.8 to about 4, from about 2.8 to about 3.7, from about 2.8 to about 3, from about 3 to about 8, from about 3 to about 7.4, from about 3 to about 7, from about 3 to about 6, from about 3 to about 5.7, from about 3 to about 5.6, from about 3 to about 5, from about 3 to about 4.2, from about 3 to about 4, from about 3 to about 3.7, from about 3.7 to about 8, from about 3.7 to about 7.4, from about 3.7 to about 7, from about 3.7 to about 6, from about 3.7 to about 5.7, from about 3.7 to about 5.6, from about 3.7 to about 5, from about 3.7 to about 4.2, from about 3.7 to about 4, from about 4 to about 8, from about 4 to about 7.4, from about 4 to about 7, from about 4 to about 6, from about 4 to about 5.7, from about 4 to about 5.6, from about 4 to about 5, from about 4 to about 4.2, from about 4.2 to about 8, from about 4.2 to about 7.4, from about 4.2 to about 7, from about 4.2 to about 6, from about 4.2 to about 5.7, from about 4.2 to about 5.6, from about 4.2 to about 5, from about 5 to about 8, from about 5 to about 7.4, from about 5 to about 7, from about 5 to about 6, from about 5 to about 5.7, from about 5 to about 5.6, from about 5.6 to about 8, from about 5.6 to about 7.4, from about 5.6 to about 7, from about 5.6 to about 6, from about 5.6 to about 5.7, from about 5.7 to about 8, from about 5.7 to about 7.4, from about 5.7 to about 7, from about 5.7 to about 6, from about 6 to about 8, from about 6 to about 7.4, from about 6 to about 7, from about 7 to about 8, from about 7 to about 7.4, from about 7.4 to about 8; or at most about 2.8, at most about 3, at most about 3.7, at most about 4, at most about 4.2, at most about 5, at most about 5.6, at most about 5.7, at most about 6, at most about 7, at most about 7.4, at most about 8; or about 2.8, about 3, about 3.7, about 4, about 4.2, about 5, about 5.6, about 5.7, about 6, about 7, about 7.4, about 8, or any ranges or values therebetween.

The fruit waste may be added in different concentrations during the treatment process. In some embodiments, the solvent is water. The fruit waste may be added to water during treatment at a concentration of at least about 5 g/L, at least about 10 g/L, at least about 12.5 g/L, at least about 25 g/L, at least about 50 g/L, at least about 62.5 g/L, at least about 75 g/L, at least about 87.5 g/L, at least about 100 g/L, at least about 125 g/L, at least about 150 g/L, at least about 175 g/L, at least about 200 g/L; or from about 5 g/L to about 200 g/L, about 5 g/L to about 175 g/L, about 5 g/L to about 150 g/L, about 5 g/L to about 125 g/L, from about 5 g/L to about 100 g/L, from about 5 g/L to about 87.5 g/L, from about 5 g/L to about 75 g/L, from about 5 g/L to about 62.5 g/L, from about 5 g/L to about 50 g/L, from about 5 g/L to about 25 g/L, from about 5 g/L to about 12.5 g/L, from about 5 g/L to about 10 g/L, from about 10 g/L to about 200 g/L, from about 10 g/L to about 175 g/L, from about 10 g/L to about 150 g/L, from about 10 g/L to about 125 g/L, from about 10 g/L to about 100 g/L, from about 10 g/L to about 87.5 g/L, from about 10 g/L to about 75 g/L, from about 10 g/L to about 62.5 g/L, from about 10 g/L to about 50 g/L, from about 10 g/L to about 25 g/L, from about 10 g/L to about 12.5 g/L, from about 12.5 g/L to about 200 g/L, from about 12.5 g/L to about 175 g/L, from about 12.5 g/L to about 150 g/L, from about 12.5 g/L to about 125 g/L, from about 12.5 g/L to about 100 g/L, from about 12.5 g/L to about 87.5 g/L, from about 12.5 g/L to about 75 g/L, from about 12.5 g/L to about 62.5 g/L, from about 12.5 g/L to about 50 g/L, from about 12.5 g/L to about 25 g/L, from about 25 g/L to about 200 g/L, from about 25 g/L to about 175 g/L, from about 25 g/L to about 150 g/L, from about 25 g/L to about 125 g/L, from about 25 g/L to about 100 g/L, from about 25 g/L to about 87.5 g/L, from about 25 g/L to about 75 g/L, from about 25 g/L to about 62.5 g/L, from about 25 g/L to about 50 g/L, from about 50 g/L to about 200 g/L, from about 50 g/L to about 175 g/L, from about 50 g/L to about 150 g/L, from about 50 g/L to about 125 g/L, from about 50 g/L to about 100 g/L, from about 50 g/L to about 87.5 g/L, from about 50 g/L to about 75 g/L, from about 50 g/L to about 62.5 g/L, from about 62.5 g/L to about 200 g/L, from about 62.5 g/L to about 175 g/L, from about 62.5 g/L to about 150 g/L, from about 62.5 g/L to about 125 g/L, from about 62.5 g/L to about 100 g/L, from about 62.5 g/L to about 87.5 g/L, from about 62.5 g/L to about 75 g/L, from about 75 g/L to about 200 g/L, from about 75 g/L to about 175 g/L, from about 75 g/L to about 150 g/L, from about 75 g/L to about 125 g/L, from about 75 g/L to about 100 g/L, from about 75 g/L to about 87.5 g/L, from about 87.5 g/L to about 200 g/L, from about 87.5 g/L to about 175 g/L, from about 87.5 g/L to about 150 g/L, from about 87.5 g/L to about 125 g/L, from about 87.5 g/L to about 100 g/L, from about 100 g/L to about 200 g/L, from about 100 g/L to about 175 g/L, from about 100 g/L to about 150 g/L, from about 100 g/L to about 125 g/L, from about 125 g/L to about 200 g/L, from about 125 g/L to about 175 g/L, from about 125 g/L to about 150 g/L, from about 150 g/L to about 200 g/L, from about 150 g/L to about 175 g/L, from about 175 g/L to about 200 g/L; or at most about 5 g/L, at most about 10 g/L, at most about 12.5 g/L, at most about 25 g/L, at most about 50 g/L, at most about 62.5 g/L, at most about 75 g/L, at most about 87.5 g/L, at most about 100 g/L, at most about 125/L, at most about 150 g/L, at most about 175/L, at most about 200 g/L; or about 5 g/L, about 10 g/L, about 12.5 g/L, about 25 g/L, about 50 g/L, about 62.5 g/L, about 75 g/L, about 87.5 g/L, about 100 g/L, about 125 g/L, about 150 g/L, about 175 g/L, about 200 g/L, or any ranges or values therebetween.

The present disclosure hence discloses a method wherein the ratio of the fruit to water is from about 5 g/L to about 200 g/L.

The leaching solution or lixiviant as mentioned earlier, comprises the extract obtained after the disclosed treatment methods and can be used without further purification or modification. The extract may also be further concentrated after the treatment to obtain a concentrate to be also used as the lixiviant. The concentrate increases the concentration of active compounds during the leaching process. In some embodiments, the leaching solution may be concentrated at least 1 time, at least 2 times, at least 3 times, at least 4 times, at least 5; or from 1 time to 5 times, from 1 time to 4 times, from 1 time to 3 times, from 1 time to 2 times, from 2 times to 5 times, from 2 times to 4 times, from 2 times to 3 times, from 3 times to 5 times, from 3 times to 4 times, from 4 times to 5 times; or at most 1 time, at most 2 times, at most 3 times, at most 4 times, at most 5 times; or 1 time, 2 times, 3 times, 4 times, or 5 times. In some preferred embodiments, the leaching solution is concentrated 4 times prior to the leaching step in step (ii).

In some embodiments, the leaching solution may be concentrated to at least half of its original volume, at least a third of its original volume, at least a quarter of its original volume, at least a fifth of its original volume, at least a sixth of its original volume; or from a sixth of its original volume to half of its original volume, from a sixth of its original volume to a third of its original volume, from a sixth of its original volume to a quarter of its original volume, from a sixth of its original volume to a fifth of its original volume, from a fifth of its original volume to half of its original volume, from a fifth of its original volume to a third of its original volume, from a fifth of its original volume to a quarter of its original volume, from a quarter of its original volume to half of its original volume, from a quarter of its original volume to a third of its original volume, from a third of its original volume to half of its original volume; or at most half of its original volume, at most a third of its original volume, at most a quarter of its original volume, at most a fifth of its original volume, at most a sixth of its original volume; or about half of its original volume, about a third of its original volume, about a quarter of its original volume, about a fifth of its original volume, about a sixth of its original volume, or any ranges or fractions therebetween. In some preferred embodiments, the leaching solution is concentrated to a quarter of its original volume prior to the leaching step in step (ii).

The black mass, crushed battery or battery waste, may be added to the leaching solution or acidified leaching solution in various concentrations without significantly affecting the leaching efficiency. In some embodiments, the battery waste may be added to the leaching solution in a concentration of at least about 1 g/L, at least about 2.5 g/L, at least about 3.75 g/L, at least about 5 g/L, at least about 6.25 g/L, at least about 7.5 g/L, at least about 8.75 g/L, at least about 10 g/L, at least about 12.5 g/L, at least about 25 g/L, at least about 30 g/L, at least about 35 g/L, at least about 40 g/L, at least about 45 g/L, at least about 50 g/L, at least about 60 g/L, at least about 70 g/L, at least about 80 g/L, at least about 90 g/L, at least about 100 g/L; or from about 1 g/L to about 100 g/L, from about 1 g/L to about 90 g/L, from about 1 g/L to about 80 g/L, from about 1 g/L to about 70 g/L, from about 1 g/L to about 60 g/L, from about 1 g/L to about 50 g/L, from about 1 g/L to about 45 g/L, from about 1 g/L to about 40 g/L, from about 1 g/L to about 35 g/L, from about 1 g/L to about 30 g/L, from about 1 g/L to about 25 g/L, from about 1 g/L to about 12.5 g/L, from about 1 g/L to about 10 g/L, from about 1 g/L to about 8.75 g/L, from about 1 g/L to about 7.5 g/L, from about 1 g/L to about 6.25 g/L, from about 1 g/L to about 5 g/L, from about 1 g/L to about 3.75 g/L, from about 1 g/L to about 2.5 g/L, from about 2.5 g/L to about 100 g/L, from about 2.5 g/L to about 90 g/L, from about 2.5 g/L to about 80 g/L, from about 2.5 g/L to about 70 g/L, from about 2.5 g/L to about 60 g/L, from about 2.5 g/L to about 50 g/L, from about 2.5 g/L to about 45 g/L, from about 2.5 g/L to about 40 g/L, from about 2.5 g/L to about 35 g/L, from about 2.5 g/L to about 30 g/L, from about 2.5 g/L to about 25 g/L, from about 2.5 g/L to about 12.5 g/L, from about 2.5 g/L to about 10 g/L, from about 2.5 g/L to about 8.75 g/L, from about 2.5 g/L to about 7.5 g/L, from about 2.5 g/L to about 6.25 g/L, from about 2.5 g/L to about 5 g/L, from about 2.5 g/L to about 3.75 g/L, from about 3.75 g/L to about 100 g/L, from about 3.75 g/L to about 90 g/L, from about 3.75 g/L to about 80 g/L, from about 3.75 g/L to about 70 g/L, from about 3.75 g/L to about 60 g/L, from about 3.75 g/L to about 50 g/L, from about 3.75 g/L to about 45 g/L, from about 3.75 g/L to about 40 g/L, from about 3.75 g/L to about 35 g/L, from about 3.75 g/L to about 30 g/L, from about 3.75 g/L to about 25 g/L, from about 3.75 g/L to about 12.5 g/L, from about 3.75 g/L to about 10 g/L, from about 3.75 g/L to about 8.75 g/L, from about 3.75 g/L to about 7.5 g/L, from about 3.75 g/L to about 6.25 g/L, from about 3.75 g/L to about 5 g/L, from about 5 g/L to about 100 g/L, from about 5 g/L to about 90 g/L, from about 5 g/L to about 80 g/L, from about 5 g/L to about 70 g/L, from about 5 g/L to about 60 g/L, from about 5 g/L to about 50 g/L, from about 5 g/L to about 45 g/L, from about 5 g/L to about 40 g/L, from about 5 g/L to about 35 g/L, from about 5 g/L to about 30 g/L, from about 5 g/L to about 25 g/L, from about 5 g/L to about 12.5 g/L, from about 5 g/L to about 10 g/L, from about 5 g/L to about 8.75 g/L, from about 5 g/L to about 4.5 g/L, from about 5 g/L to about 6.25 g/L, from about 6.25 g/L to about 100 g/L, from about 6.25 g/L to about 90 g/L, from about 6.25 g/L to about 80 g/L, from about 6.25 g/L to about 70 g/L, from about 6.25 g/L to about 60 g/L, from about 6.25 g/L to about 50 g/L, from about 6.25 g/L to about 45 g/L, from about 6.25 g/L to about 40 g/L, from about 6.25 g/L to about 35 g/L, from about 6.25 g/L to about 30 g/L, from about 6.25 g/L to about 25 g/L, from about 6.25 g/L to about 12.5 g/L, from about 6.25 g/L to about 10 g/L, from about 6.25 g/L to about 8.75 g/L, from about 6.25 g/L to about 7.5 g/L, from about 7.5 g/L to about 100 g/L, from about 7.5 g/L to about 90 g/L, from about 7.5 g/L to about 80 g/L, from about 7.5 g/L to about 70 g/L, from about 7.5 g/L to about 60 g/L, from about 7.5 g/L to about 50 g/L, from about 7.5 g/L to about 45 g/L, from about 7.5 g/L to about 40 g/L, from about 7.5 g/L to about 35 g/L, from about 7.5 g/L to about 30 g/L, from about 7.5 g/L to about 25 g/L, from about 7.5 g/L to about 12.5 g/L, from about 7.5 g/L to about 10 g/L, from about 7.5 g/L to about 8.75 g/L, from about 8.75 g/L to about 100 g/L, from about 8.75 g/L to about 90 g/L, from about 8.75 g/L to about 80 g/L, from about 8.75 g/L to about 70 g/L, from about 8.75 g/L to about 60 g/L, from about 8.75 g/L to about 50 g/L, from about 8.75 g/L to about 45 g/L, from about 8.75 g/L to about 40 g/L, from about 8.75 g/L to about 35 g/L, from about 8.75 g/L to about 30 g/L, from about 8.75 g/L to about 25 g/L, from about 8.75 g/L to about 12.5 g/L, from about 8.75 g/L to about 10 g/L, from about 10 g/L to about 100 g/L, from about 10 g/L to about 90 g/L, from about 10 g/L to about 80 g/L, from about 10 g/L to about 70 g/L, from about 10 g/L to about 60 g/L, from about 10 g/L to about 50 g/L, from about 10 g/L to about 45 g/L, from about 10 g/L to about 40 g/L, from about 10 g/L to about 35 g/L, from about 10 g/L to about 30 g/L, from about 10 g/L to about 25 g/L, from about 10 g/L to about 12.5 g/L, from about 12.5 g/L to about 100 g/L, from about 12.5 g/L to about 90 g/L, from about 12.5 g/L to about 80 g/L, from about 12.5 g/L to about 70 g/L, from about 12.5 g/L to about 60 g/L, from about 12.5 g/L to about 50 g/L, from about 12.5 g/L to about 45 g/L, from about 12.5 g/L to about 40 g/L, from about 12.5 g/L to about 35 g/L, from about 12.5 g/L to about 30 g/L, from about 12.5 g/L to about 25 g/L; from about 25 g/L to about 100 g/L, from about 25 g/L to about 90 g/L, from about 25 g/L to about 80 g/L, from about 25 g/L to about 70 g/L, from about 25 g/L to about 60 g/L, from about 25 g/L to about 50 g/L, from about 25 g/L to about 45 g/L, from about 25 g/L to about 40 g/L, from about 25 g/L to about 35 g/L, from about 25 g/L to about 30 g/L, from about 30 g/L to about 100 g/L, from about 30 g/L to about 90 g/L, from about 30 g/L to about 80 g/L, from about 30 g/L to about 70 g/L, from about 30 g/L to about 60 g/L, from about 30 g/L to about 50 g/L, from about 30 g/L to about 45 g/L, from about 30 g/L to about 40 g/L, from about 30 g/L to about 35 g/L, from about 35 g/L to about 100 g/L, from about 35 g/L to about 90 g/L, from about 35 g/L to about 80 g/L, from about 35 g/L to about 70 g/L, from about 35 g/L to about 60 g/L, from about 35 g/L to about 50 g/L, from about 35 g/L to about 45 g/L, from about 35 g/L to about 40 g/L, from about 40 g/L to about 100 g/L, from about 40 g/L to about 90 g/L, from about 40 g/L to about 80 g/L, from about 40 g/L to about 70 g/L, from about 40 g/L to about 60 g/L, from about 40 g/L to about 50 g/L, from about 40 g/L to about 45 g/L, from about 45 g/L to about 50 g/L, from about 50 g/L to about 100 g/L, from about 50 g/L to about 90 g/L, from about 50 g/L to about 80 g/L, from about 50 g/L to about 70 g/L, from about 50 g/L to about 60 g/L, from about 60 g/L to about 100 g/L, from about 60 g/L to about 90 g/L, from about 60 g/L to about 80 g/L, from about 60 g/L to about 70 g/L, from about 70 g/L to about 100 g/L, from about 70 g/L to about 90 g/L, from about 70 g/L to about 80 g/L, from about 80 g/L to about 100 g/L, from about 80 g/L to about 90 g/L, from about 90 g/L to about 100; or at most about 1 g/L, at most about 2.5 g/L, at most about 3.75 g/L, at most about 5 g/L, at most about 6.25 g/L, at most about 7.5 g/L, at most about 8.75 g/L, at most about 10 g/L, at most about 12.5 g/L, at most about 25 g/L, at most about 50 g/L, at most about 60 g/L, at most about 70 g/L, at most about 80 g/L, at most about 90 g/L, at most about 100 g/L; or about 1 g/L, about 2.5 g/L, about 3.75 g/L, about 5 g/L, about 6.25 g/L, about 7.5 g/L, about 8.75 g/L, about 10 g/L, about 12.5 g/L, about 25 g/L, about 30 g/L, about 35 g/L, about 40 g/L, about 45 g/L, about 50 g/L, about 60 g/L, about 70 g/L, about 80 g/L, about 90 g/L, about 100 g/L, or any ranges or values therebetween.

The present disclosure hence discloses a method comprising adding a crushed battery to the leaching solution in a ratio of about 1 g/L to about 100 g/L.

A small amount of heat may be introduced to increase the leaching efficiency of the leaching process. In some embodiments, the leaching process or step (ii) may be performed at a temperature of at least about 40° C., at least about 50° C., at least about 60° C., at least about 70° C., at least about 80° C., at least about 90° C., at least about 100° C.; or from about 40° C. to about 100° C., from about 40° C. to about 90° C., from about 40° C. to about 80° C., from about 40° C. to about 70° C., from about 40° C. to about 60° C., from about 40° C. to about 50° C., from about 50° C. to about 100° C., from about 50° C. to about 90° C., from about 50° C. to about 80° C., from about 50° C. to about 70° C., from about 50° C. to about 60° C., from about 60° C. to about 100° C., from about 60° C. to about 90° C., from about 60° C. to about 80° C., from about 60° C. to about 70° C., from about 70° C. to about 100° C., from about 70° C. to about 90° C., from about 70° C. to about 80° C., from about 80° C. to about 100° C., from about 80° C. to about 90° C., from about 90° C. to about 100° C.; or at most about 40° C., at most about 50° C., at most about 60° C., at most about 70° C., at most about 80° C., at most about 90° C., at most about 100° C.; or about 40° C., about 50° C., about 60° C., about 70° C., about 80° C., about 90° C., about 100° C., or any ranges or values therebetween.

The present disclosure hence discloses a method comprising performing step (iii) at from about 40° C. to about 100° C.

The inventors have also found that the leaching process may be performed for various durations to complete the leaching process. In some embodiments, the leaching process or step (ii) may be performed for at least about 1 hour, at least about 2 hours, at least about 4 hours, at least about 6 hours, at least about 7 hours, at least about 8 hours, at least about 12 hours, at least about 16 hours, at least about 24 hours; or from about 1 hour to about 24 hours, from about 1 hour to about 16 hours, from about 1 hour to about 12 hours, from about 1 hour to about 8 hours, from about 1 hour to about 7 hours, from about 1 hour to about 6 hours, from about 1 hour to about 4 hours, from about 1 hour to about 2 hours, from about 2 hours to about 24 hours, from about 2 hours to about 16 hours, from about 2 hours to about 12 hours, from about 2 hours to about 8 hours, from about 2 hours to about 7 hours, from about 2 hours to about 6 hours, from about 2 hours to about 4 hours, from about 4 hours to about 24 hours, from about 4 hours to about 16 hours, from about 4 hours to about 12 hours, from about 4 hours to about 8 hours, from about 4 hours to about 7 hours, from about 4 hours to about 6 hours, from about 6 hours to about 24 hours, from about 6 hours to about 16 hours, from about 6 hours to about 12 hours, from about 6 hours to about 8 hours, from about 6 hours to about 7 hours, from about 7 hours to about 24 hours, from about 7 hours to about 16 hours, from about 7 hours to about 12 hours, from about 7 hours to about 8 hours, from about 8 hours to about 24 hours, from about 8 hours to about 16 hours, from about 8 hours to about 12 hours, from about 12 hours to about 24 hours, from about 12 hours to about 16 hours, from about 16 hours to about 24 hours; or at most about 1 hour, at most about 2 hours, at most about 4 hours, at most about 6 hours, at most about 7 hours, at most about 8 hours, at most about 12 hours, at most about 16 hours, at most about 24 hours; or about 1 hour, about 2 hours, about 4 hours, about 6 hours, about 7 hours, about 8 hours, about 12 hours, about 16 hours, about 24 hours, or any ranges or values therebetween.

The present disclosure hence discloses a method comprising performing step (iii) for at least 1 hour, preferably 4 hours.

The fruit used may be mixed fruit, instead of only a single fruit. Mixed fruit may be used in the leaching method without affecting the leaching efficiency. The fruit may be orange, lemon, lime, pomelo, pineapple, papaya, mango, honeydew, melon, pear, apple, banana, blackberry, raspberry, cranberry, tamarind, grape, watermelon, kiwi, plum, peach, sweet potato, avocado, cucumber, dragon fruit, guava, jackfruit, durian, beetroot, carrot, soursop, and mixtures thereof.

The fruit may be the whole of the fruit, or its peel, flesh, seeds, or any combination and parts thereof. In an embodiment, the fruit may be primarily fruit peels. The fruit peels may be peels that have been discarded after the flesh of the fruit has been consumed, and thus are referred to as “waste fruit peels” or “waste peels”, or simply “waste”.

The present disclosure hence discloses a method, wherein the fruit is selected from the group consisting of orange, lemon, lime, pomelo, pineapple, papaya, mango, honeydew, melon, pear, apple, banana, blackberry, raspberry, cranberry, tamarind, grape, watermelon, kiwi, plum, peach, sweet potato, avocado, cucumber, dragon fruit, guava, jackfruit, durian, beetroot, carrot, soursop, and mixtures thereof, and wherein the fruit comprises its peel, flesh and/or seeds.

The fruit may be untreated, or be in powder or blended form. The fruit may be untreated, or mechanically treated to improve the conversion of saccharides to the active compounds. The fruit may be mechanically treated, for example the fruit may be cut, chopped, shredded, grinded, grated and/or blended. In other embodiments, the fruit may be dried substantially or completely using the sun, heat, high temperatures, driers, ovens, freeze driers or dehydrators. In other embodiments, the fruit may be mechanically treated first, then dried. In some other embodiments, the fruit may be dried first then mechanically treated. In further embodiments, the fruit may be simultaneously dried and mechanically treated. In some embodiments, the fruit may be mechanically treated prior to the treatment step (i).

The present disclosure has demonstrated that it is capable of leaching various metal ions from batteries. The metal ions recovered may be lithium, nickel, manganese, cobalt, zinc, copper, iron, silver, vanadium, silicon, titanium, tin, chromium, aluminium or any combinations thereof. In some preferred embodiments, the metal ions are selected from the group consisting of lithium, manganese, nickel, cobalt, aluminium, copper or combinations and mixtures thereof.

The metal ions may be nickel, manganese cobalt, lithium, vanadium, silicon, titanium, tin, chromium, copper, and/or aluminium ions.

The present disclosure further relates to a method of obtaining a metal salt from a battery, the method comprising:
(i) adding fruit to a solvent to form a mixture;
(ii) subjecting the mixture of step (i) to fermentation or heat treatment to obtain a leaching solution;
(iii) adding a crushed battery to the leaching solution thereby obtaining a leachate comprising metal ions; and
(iv) adding a precipitating agent to the leachate to obtain a precipitate comprising the metal salt.

The precipitating agent may be selected from the group consisting of sodium hydroxide, sodium chloride, sodium bisulfate, monosodium phosphate, disodium phosphate, trisodium phosphate, sodium carbonate, sodium bicarbonate, sodium sulfite, sodium bisulfite, calcium hydroxide, potassium hydroxide, potassium chloride, potassium carbonate, potassium bicarbonate, sodium oxalate, ammonium oxalate, ammonium hydroxide, ammonium bisulfate, ammonium phosphate, ammonium carbonate, ammonium bicarbonate, ammonium sulfite, oxalic acid, phosphoric acid, carbonic acid, magnesium hydroxide and any mixture thereof.

The precipitate may comprise cobalt salt, manganese salt and/or nickel salt

The present disclosure further relates to a method of recovering and regenerating a lithium cathode material from a lithium-ion battery (LIB), the method comprising:
(i) adding fruit to a solvent to form a mixture;
(ii) subjecting the mixture of step (i) to fermentation or heat treatment to obtain a leaching solution;
(iii) adding a crushed LIB to the leaching solution thereby obtaining a leachate comprising metal ions;
(iv) adding a precipitating agent to the leachate of step (iii), thereby obtaining a precipitate comprising metal salt; and
(v) mixing the precipitate of step (iv) with a lithium salt and heating the resulting mixture to obtain a lithium cathode material.

The lithium salt may be selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

The resulting mixture of step (v) may be heated at various temperatures to effect conversion to obtain a lithium cathode material. In some embodiments, the temperature may be at least about 400° C., at least about 500° C., at least about 600° C., at least about 700° C., at least about 800° C., at least about 900° C., at least about 7000° C., or from about 400° C. to about 1000° C., from about 400° C. to about 900° C., from about 400° C. to about 800° C., from about 400° C. to about 700° C., from about 400° C. to about 600° C., from about 400° C. to about 500° C., from about 500° C. to about 1000° C., from about 500° C. to about 900° C., from about 500° C. to about 800° C., from about 500° C. to about 700° C., from about 500° C. to about 600° C., from about 600° C. to about 1000° C., from about 600° C. to about 900° C., from about 600° C. to about 800° C., from about 600° C. to about 700° C., from about 700° C. to about 1000° C., from about 700° C. to about 900° C., from about 700° C. to about 800° C., from about 800° C. to about 1000° C., from about 800° C. to about 900° C., from about 900° C. to about 1000° C., or at most about 400° C., at most about 500° C., at most about 600° C., at most about 700° C., at most about 800° C., at most about 900° C., at most about 1000° C., or about 400° C., about 500° C., about 600° C., about 700° C., about 800° C., about 900° C., about 1000° C., or any ranges or values therebetween. In a preferred embodiment, the present invention discloses a method comprising a step (v) of mixing the precipitate of step (iv) with a lithium salt and heating the resulting mixture at a temperature of from about 400° C. to about 1000° C. to obtain a lithium cathode material.

The resulting mixture may also be heated for various durations to effect conversion to obtain a lithium cathode material. In some embodiments, the duration may be at least about 4 hours, at least about 8 hours, at least about 10 hours, at least about 12 hours, at least about 16 hours, at least about 20 hours, at least about 24 hours, at least about 28 hours, at least about 30 hours, at least about 32 hours, at least about 36 hours, at least about 40 hours, at least about 44 hours, at least about 48 hours, or from about 4 hours to about 48 hours, from about 4 hours to about 44 hours, from about 4 hours to about 40 hours, from about 4 hours to about 36 hours, from about 4 hours to about 32 hours, from about 4 hours to about 30 hours, from about 4 hours to about 28 hours, from about 4 hours to about 24 hours, from about 4 hours to about 20 hours, from about 4 hours to about 16 hours, from about 4 hours to about 12 hours, from about 4 hours to about 10 hours, from about 4 hours to about 8 hours, from about 8 hours to about 48 hours, from about 8 hours to about 44 hours, from about 8 hours to about 40 hours, from about 8 hours to about 36 hours, from about 8 hours to about 32 hours, from about 8 hours to about 30 hours, from about 8 hours to about 28 hours, from about 8 hours to about 24 hours, from about 8 hours to about 20 hours, from about 8 hours to about 16 hours, from about 8 hours to about 12 hours, from about 8 hours to about 10 hours, from about 10 hours to about 48 hours, from about 10 hours to about 44 hours, from about 10 hours to about 40 hours, from about 10 hours to about 36 hours, from about 10 hours to about 32 hours, from about 10 hours to about 30 hours, from about 10 hours to about 28 hours, from about 10 hours to about 24 hours, from about 10 hours to about 20 hours, from about 10 hours to about 16 hours, from about 10 hours to about 12 hours, from about 12 hours to about 48 hours, from about 12 hours to about 44 hours, from about 12 hours to about 40 hours, from about 12 hours to about 36 hours, from about 12 hours to about 32 hours, from about 12 hours to about 30 hours, from about 12 hours to about 28 hours, from about 12 hours to about 24 hours, from about 12 hours to about 20 hours, from about 12 hours to about 16 hours, from about 16 hours to about 48 hours, from about 16 hours to about 44 hours, from about 16 hours to about 40 hours, from about 16 hours to about 36 hours, from about 16 hours to about 32 hours, from about 16 hours to about 30 hours, from about 16 hours to about 28 hours, from about 16 hours to about 24 hours, from about 16 hours to about 20 hours, from about 20 hours to about 48 hours, from about 20 hours to about 44 hours, from about 20 hours to about 40 hours, from about 20 hours to about 36 hours, from about 20 hours to about 32 hours, from about 20 hours to about 30 hours, from about 20 hours to about 28 hours, from about 20 hours to about 24 hours, from about 24 hours to about 48 hours, from about 24 hours to about 44 hours, from about 24 hours to about 40 hours, from about 24 hours to about 36 hours, from about 24 hours to about 32 hours, from about 24 hours to about 30 hours, from about 24 hours to about 28 hours, from about 28 hours to about 48 hours, from about 28 hours to about 44 hours, from about 28 hours to about 40 hours, from about 28 hours to about 36 hours, from about 28 hours to about 32 hours, from about 28 hours to about 30 hours, from about 30 hours to about 48 hours, from about 30 hours to about 44 hours, from about 30 hours to about 40 hours, from about 30 hours to about 36 hours, from about 30 hours to about 32 hours, from about 32 hours to about 48 hours, from about 32 hours to about 44 hours, from about 32 hours to about 40 hours, from about 32 hours to about 36 hours, from about 36 hours to about 48 hours, from about 36 hours to about 44 hours, from about 36 hours to about 40 hours, from about 40 hours to about 48 hours, from about 40 hours to about 44 hours, from about 44 hours to about 48 hours, or at most about 4 hours, at most about 8 hours, at most about 10 hours, at most about 12 hours, at most about 16 hours, at most about 20 hours, at most about 24 hours, at most about 28 hours, at most about 30 hours, at most about 32 hours, at most about 36 hours, at most about 40 hours, at most about 44 hours, at most about 48 hours, or about 4 hours, about 8 hours, about 10 hours, about 12 hours, about 16 hours, about 20 hours, about 24 hours, about 28 hours, about 30 hours, about 32 hours, about 36 hours, about 40 hours, about 44 hours, about 48 hours, or any ranges or values therebetween. In a preferred embodiment the present invention discloses a method comprising a step (v) of mixing the precipitate of step (iv) with a lithium salt and heating the resulting mixture from about 4 hours to about 48 hours to obtain a lithium cathode material.

In some other preferred embodiments, the present invention discloses a method comprising a step (v) of mixing the precipitate of step (iv) with a lithium salt and heating the resulting mixture at a temperature of about 400° C. to about 1000° C. for about 4 hours to about 48 hours to obtain a lithium cathode material.

The lithium cathode material may be selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium nickel oxide (LiNiO₂), lithium manganese dioxide (LiMnO₂), lithium manganese nickel oxide (LiNi_{0.5}Mn_{1.5}O₄)(LMNO), lithium manganese phosphate (LiMnPO₄), lithium nickel phosphate (LiNiPO₄), lithium cobalt phosphate (LiCoPO₄), lithium nickel cobalt aluminium oxide (LiNi_{0.8}CoAl_{0.05}O₂), and any mixture thereof.

The present disclosure also relates to a method of obtaining metal ions from a battery, comprising:
(i) mechanically pre-treating (cutting, blending, drying) fruit waste;
(ii) treating fruit waste by either one of following methods: heat treatment, hydrothermal treatment, microwave-assisted treatment or fermentation;
(iii) extracting the supernatant from the pre-treated mixture;
(iv) adding LIB waste powder to the pre-treated mixture;
(v) applying heat and stirring/agitation to the reaction mixture; and
(vi) extracting selected metals ion from LIBs waste black mass powder.

### EXAMPLES

Non-limiting examples of the invention and comparative examples will be further described in greater detail by reference to specific examples, which should not be construed as in any way limiting the scope of the invention.

### Example 1: Processing Fruit Peels

The collected fruit peel waste samples were subjected to mechanical pre-treatments including categorization, cutting, blending immediately post-collection and freeze-dried at −50° C. for 1 day to 3 days to homogenize the samples and preserve their active reducing components. Dried fruit was then milled to obtain fine powder before further processing.

### Example 2: General Procedure for Treating Dried Fruit Peels

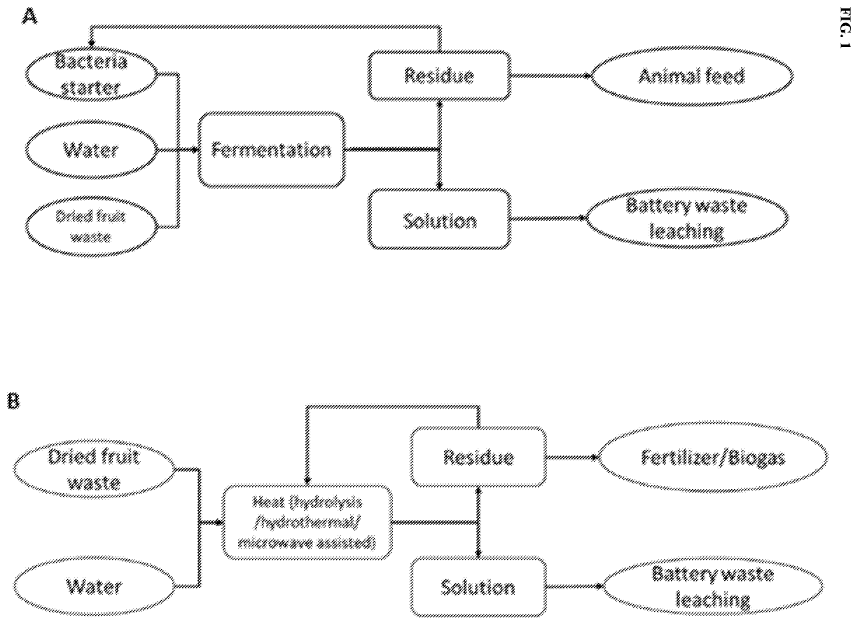

Several pre-treatment methods were performed to process fruit peel waste and are shown in FIG. 1. Unless stated otherwise, 10 g of dried fruit peel was mixed in 200 ml of DI water to form a fruit waste-water mixture to be used for the described treatment processes.

For comparison purposes, pre-treatment using hot water extraction and pre-treatment using sonication were also performed.

For the pre-treatment using hot water extraction, DI water was first heated to 100° C., after which it was poured into the fruit waste and left to cool with stirring for not more than 5 minutes. No additional heat was supplied during the stirring.

For the pre-treatment using sonication, the fruit waste-water mixture was added to a bottle and placed in a sonication bath for one day. The mixture was sonicated intermittently during the process and the temperature in the sonication bath was set to not exceed 45° C.

For the pre-treatment using fermentation of the present invention, about 200 mg of ferment starter (whey protein) was added in a fruit waste-water mixture in a closed bottle. The mixture was stirred continuously for 3 days at room temperature. The solution after fermentation was then separated from the residue to form the extract. The extract is then used as the lixiviant in subsequent steps without further purification. It is noted that the residue formed from fermentation could also be re-used as ferment starter (around 500 mg) in following batches. Additionally, because of the high content of beneficial bacteria in the residue, the residue can also be collected after and used as animal feed.

TABLE 1
Conditions for heat treating fruit waste

| Method | Hydrolysis | Hydrothermal | Microwave assisted |
|---|---|---|---|
| Temperature (° C.) | 90 | 180 | 180 |
| Treatment duration | 3 days | 10 hours | 35 min (10 ramp, |
| | | | 15 hold, 10 cool) |

| | |
|---|---|
| Fruit loading | 100 g/L |

In the pre-treatment using heat treatment of the present invention, the fruit waste-water mixture was either heated at 90° C. in a closed bottle for 3 days in a hydrolysis process, or at 180° C. in a hydrothermal autoclave reactor for 10 hours in a hydrothermal process, or at 180° C. in a microwave autoclave reactor for 35 minutes in a microwave-assisted process. After the treatment, the solution was then separated from the residue to form the extract. The extract is then used as the lixiviant in subsequent steps without further purification. The residue collected from the heat-treatment processes can also be added into subsequent fruit waste-water mixtures to be further heat-treated or applied in fertilizer and biogas.

### Example 2a: Hydrolysis Pre-Treatment

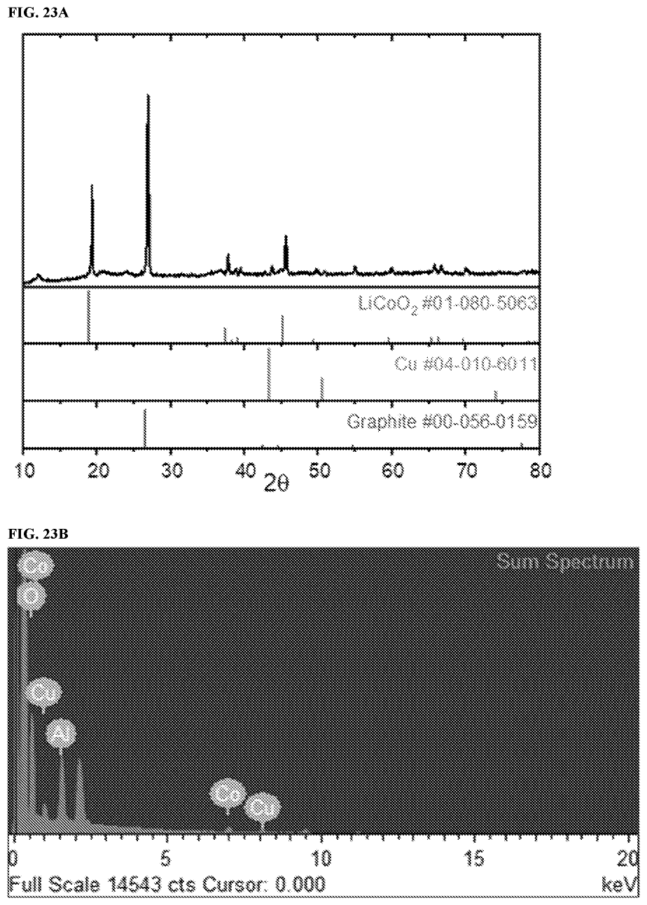

In the pre-treatment using hydrolysis, 6 g of orange peels were mixed in 60 ml DI water in a closed bottle (100 g/L). The solution was heated at 90° C. and stirred for from 1 day to 8 days (FIG. 24a). To prevent the orange peel solution from boiling and to maximize the extracting proficiency, the heating temperature was kept constant across all samples. The treating duration was examined from 1 day to 8 days. From FIG. 24a, the pH of hydrolysis solution stabilized after 3 days. Further, no significant changes in the pH and antioxidant capacity from the FRAP assay (FIG. 24b) was observed after 3 days as well. This suggests 3 days as being sufficient for hydrolysis.

### Example 2b: Hydrothermal Pre-Treatment

TABLE 2
pH value of hydrothermal orange peel extract
at under different hydrothermal conditions

| Duration | pH | Temperature | pH |
|---|---|---|---|
| 1 hours | 4.16 | 90° C. | 4.25 |
| 2 hours | 4.02 | 120° C. | 4.06 |
| 3 hours | 3.81 | 150° C. | 3.95 |
| 4 hours | 3.75 | 170° C. | 3.79 |
| 5 hours | 3.74 | 180° C. | 3.78 |
| 10 hours | 3.77 | 190° C. | 3.83 |
| | | 200° C. | 3.81 |

In the hydrothermal pre-treatment, 3 g of orange peels were mixed in 30 ml of DI water (100 g/L) in a 50 ml hydrothermal autoclave reactor.

For the duration studies, the heating temperature was kept at 180° C. while the heating duration was varied from 1 hour to 10 hours. For the temperature study, the sample was heated for 10 hours at various temperature from 90° C. to 200° C. pH results from the studies are shown in Table 2.

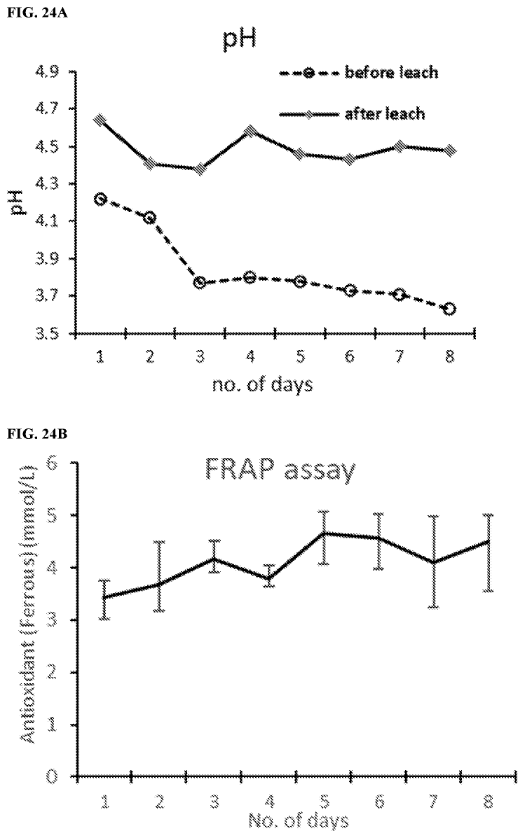

Referring to Table 2, the pH of the fruit extract stabilized either after 4 hours of heating or at 170° C. The antioxidant capacity of the 200° C. sample from FRAP assays (FIG. 25b) was higher than samples heated at other temperatures. Further, the antioxidant capacity steadied at around 10.5 mmol/L of ferrous equivalent after 3 hours of heating (FIG. 25a). Interestingly, the antioxidant capacity of the fruit extract which had undergone hydrothermal treatment was generally 4 times higher than a fruit extract which had undergone hydrolysis (around 2.8 mmol/L of ferrous equivalent). Conclusively, conditions of 200° C. and 4 hours were used for hydrothermal method in subsequent studies.

### Example 2c: Microwave-Assisted Pre-Treatment

TABLE 3
pH value of microwave OP extract at different treatment conditions

| Temperature | pH | Time (min) | pH |
|---|---|---|---|
| 70° C. | 4.38 | 1 | 4.00 |
| 90° C. | 4.40 | 5 | 3.81 |
| 110° C. | 4.42 | 10 | 3.67 |
| 120° C. | 4.33 | 15 | 3.57 |
| 135° C. | 4.24 | 20 | 3.57 |
| 150° C. | 4.16 | 30 | 3.52 |
| 180° C. | 3.67 | 40 | 3.52 |
| 210° C. | 3.14 | | |

In the microwave assisted pre-treatment, 3 g of orange peels were mixed in 30 ml of DI water (100 g/L) in a 100 ml microwave-assisted autoclave reactor. In the temperature study, the mixture was heated at specific temperatures from 70° C. to 210° C. while the holding duration was fixed at 10 minutes. In the time study, the mixture was heated for various holding durations from 1 minute to 40 minutes, while the temperature was fixed at 180° C. Meanwhile, the ramping time and cooling time were both set at 10 min across all studies. Specially, a sample was treated at 70° C. for 60 minutes to evaluate the low temperature and long heating duration effect. pH results are shown in Table 3.

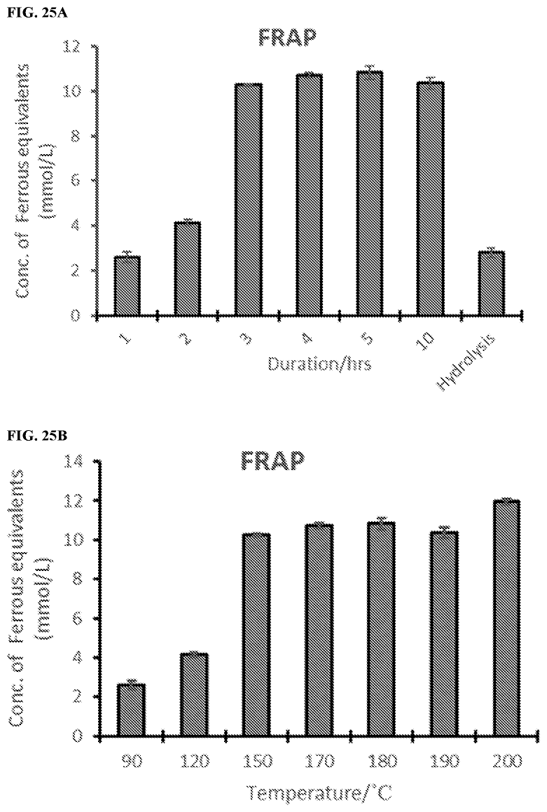

From Table 3, the pH of the orange peel extracts was found to decrease both with the increase in temperature and reaction duration. At 210° C., the pH was the lowest and the antioxidant capacity from FRAP assay (FIG. 26a) was the highest. However, due to safety precautions of autoclave reaction, 180° C. was instead used in subsequent studies. For the time study, the antioxidant capacity peaked at 15.3 mmol/L of ferrous equivalent when the holding duration was 15 min (FIG. 26b).

As such, the conditions of 180° C. and 10 minutes of ramping, 15 minutes of holding and 10 minutes of cooling (total 35 min) were used in subsequent microwave-assisted treatment studies.

### Example 2d: Fermentation Pre-Treatment

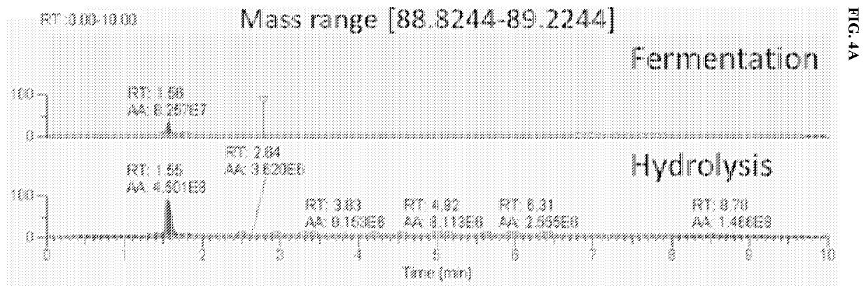

Antioxidant activity of various fruit peel fermented extracts were evaluated by ABTS radical scavenging assay, DPPH radical scavenging assay and FRAP assays. While the ABTS assay is suitable for determining hydrophilic and lipophilic compounds with anti-oxidative properties like phenolics, the DPPH assay is more reactive towards methanol-soluble compounds such as flavonoids. From FIG. 5a, the DPPH scavenging activity of all samples were significant (>60%). Amongst these, the papaya extract had the highest DPPH scavenging activity. Whereas in the ABTS and FRAP assays (FIG. 5b, c), the mango extract had highest antioxidant capacity compared to the rest. Referring to Table 1, all fermented fruit extracts had mildly acidic pHs, which were correlated directly to leaching efficiency in subsequent Examples. The watermelon and banana extracts had higher pHs than other fruit extracts, which implied a lower organic acid content. As shown in subsequent Examples, the watermelon and banana extracts showed lower leaching efficiencies than other fermented fruit extracts.

TABLE 4
pH of different fermented fruit extracts

| | Orange | Papaya | Mango | Honeydew | Pineapple | Lemon | Pomelo | Watermelon | Banana |
|---|---|---|---|---|---|---|---|---|---|
| pH | 3.32 | 3.31 | 3.4 | 3.59 | 3.62 | 3.73 | 3.84 | 4.1 | 5.1 |

### Example 3: Characterising the Extract Produced after Pre-Treatment

### Example 3a: Active Compounds in Extract after Pre-Treatment

To better examine the compositional make-up of the orange peel extract after the above-mentioned treatments, the samples were further characterized by Fourier-Transformed Infrared Spectroscopy (FTIR), Proton Nuclear Magnetic Resonance (¹H-NMR) and Liquid Chromatography-Mass Spectrometry (LC-MS).

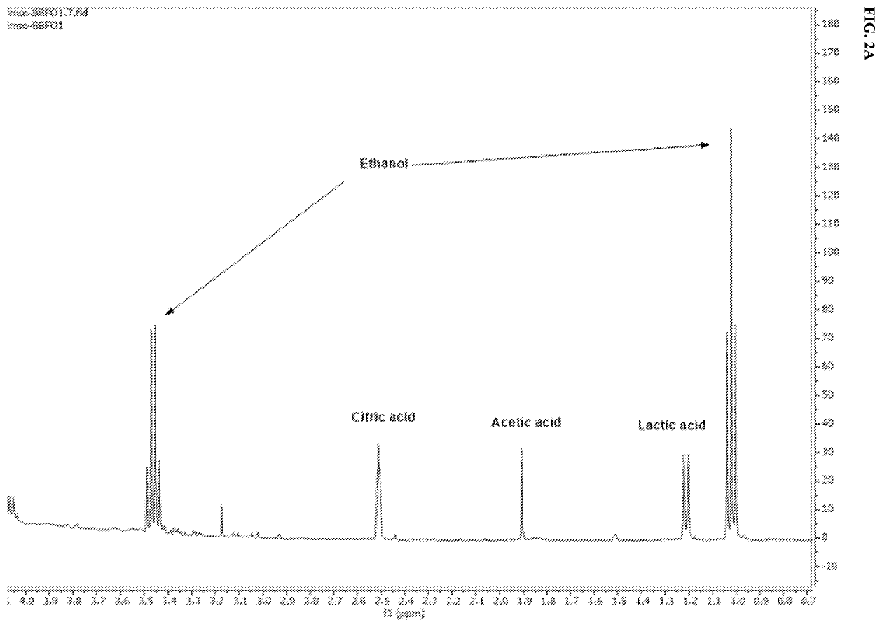

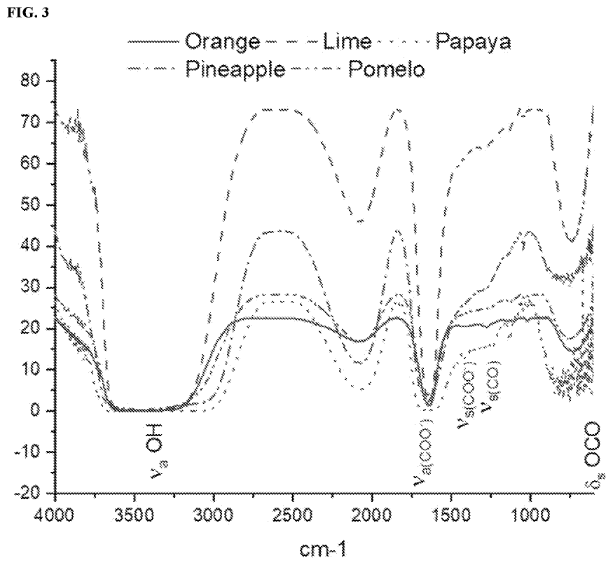

FIGS. 2a and 2b show the NMR spectra of orange peel extract after fermentation. Various simple acids were observed, including citric acid, acetic acid, lactic acid, and glycolic acid. The presence of citric acid, acetic acid and lactic acid after both fermentation and hydrolysis were further confirmed via LC-MS in FIGS. 4a to 4c. In the LC-MS studies, the fermented extract was diluted 100 times prior to each run. While citric acid, acetic acid and lactic acid were observed in the extracts after both fermentation and hydrolysis, the formation of glycolic acid was only observed after fermentation and not after hydrolysis. Conversely, the formation of gluconic acid was only observed after hydrolysis and not after fermentation (FIG. 4d).

These acids serve as proton donors or acid sources in the reductive leaching reactions. Some of these acids also serve as reducing agents because of their antioxidative properties, e.g., ascorbic acid and lactic acid. It is further hypothesised that the acids may additionally function as chelating agents to help dissolve the metal ions into the lixiviant, particularly Co.

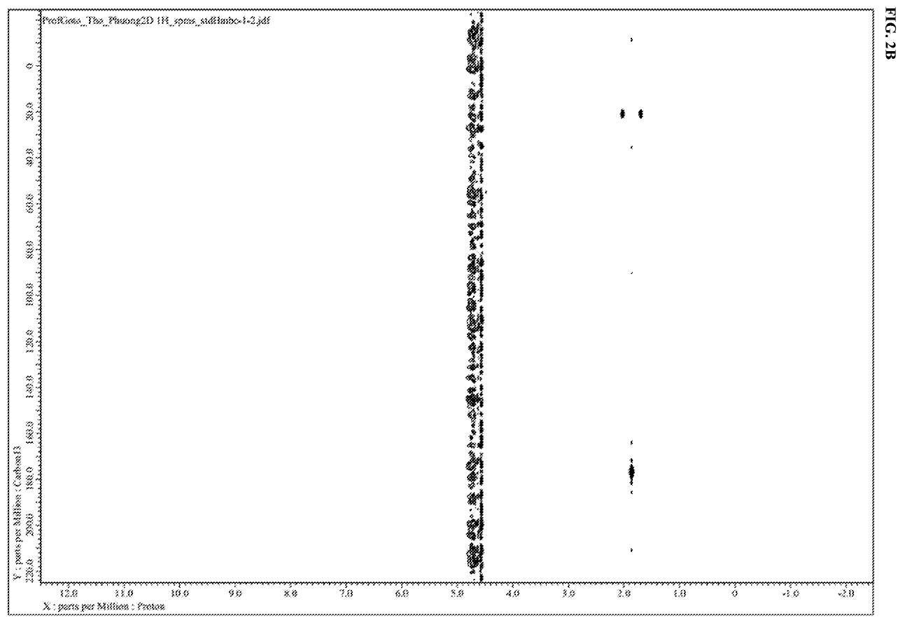

FT-IR studies performed on fruit extracts (FIG. 3) indicate significant amounts of flavonoids and phenolics present in the extract after fermentation. It is also hypothesised that they may serve as additional reducing sources during the leaching reaction.

### Example 4: Spent LIBs

Black mass derived from 3 different types of LIBs, namely Co-rich (LiCoO₂), NMC (LiMnₓNi_{y}Co_{y}O₂) and Ni-rich (LiNiO₂) black mass were used in this study. Co-rich waste powder was chosen as a recycling objective of the fermentation study.

The black masses were supplied by SeCure Waste Management Ltd. A brief description of the treatment follows below.

The batteries were first pre-sorted and then discharged using brine solution. The steel casing and plastic casing may optionally be manually separated after discharge. Afterwards, they were mechanically processed (by means of crushing and/or shredding) and subsequently sieved using a mesh with a cut-off size of 74 μm.

### Example 5: Characterizing Black Mass

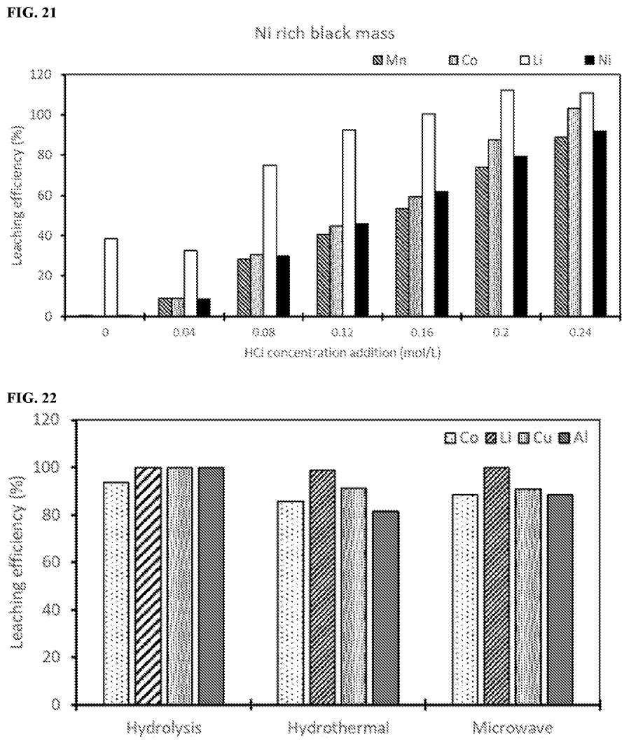

The XRD patterns (FIG. 23a) and EDX spectra (FIG. 23b) of the Co-rich black mass in Example 4 indicated that the black mass contained graphite, cathode material, aluminium, copper metal and impurities from the battery casings.

### Example 6: General Procedure for Leaching Metal Ions

A general procedure for leaching metal ions follows below.

Battery waste powder was mixed in the supernatant isolated in Example 2. No other precursor or additive was added. The reaction was held at a specific temperature for a specific duration. After reaction, the leachate was separated from the residue for further metal recovery. The residue was then treated to recycle the graphite. The leaching efficiency of different metals (e.g. Co, Li, Ni, Mn) were evaluated by Inductively Coupled Plasma—Optical Emission Spectrometry (ICP-OES).

To recover the metal ions from the leachate, the concentration of the metal ions was calculated from the ICP-OES results of the leachate, and a corresponding volume of (NH₄)₂C₂O₄ solution (0.3 M) was added to 100 ml of leachate and the mixture stirred at 1000 rpm in volumetric flask for 1 hour. The metal oxalate precipitates were then filtered out from the solution. The metal concentration of the solution before and after precipitation, weight percentage of precipitate powder and recovery efficiency were measured by ICP-OES.

### Example 6a: Leaching Metal Ions with Orange Extract from Different Pre-Treatments

Orange peels were used as a representative source of agricultural waste in the leaching reaction. Meanwhile, Co-rich black mass, which mostly contains Co and Li metals, was chosen as battery waste powder. The amount of Mn and Ni in Co-rich black mass is insignificant.

To compare the advantages of fermentation to other treatment methods, extracts from dried orange peels were also prepared using the sonication, hot-extraction, heat treatment and hydrothermal treatment methods as described in Example 2. The orange peel to water ratio for each sonication and hot-extraction was set at 50 g/L, while the ratio for heat and hydrothermal extraction was kept at 100 g/L.

After processing, the pH of the extracts after fermentation, hydrolysis and hydrothermal treatment were 3.4, 3.9 and 3.8 respectively, while the pH of the extracts after sonication and hot water extraction had higher pH at 4.4 and 4.9 respectively. These results indicate that a high amount of acid was produced or extracted by fermentation, heat treatment and hydrothermal treatment.

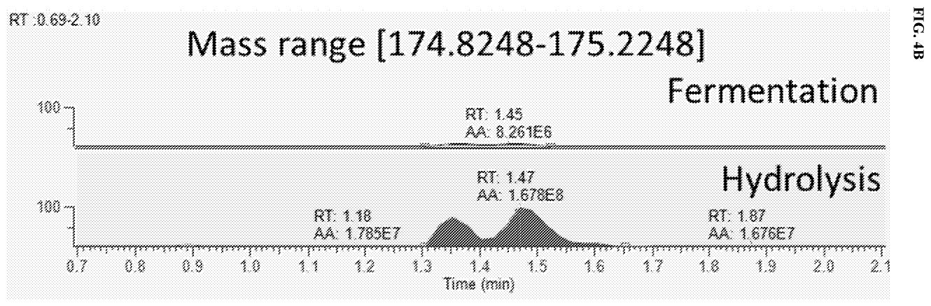

To investigate the leaching potential of the extracts, 200 mg of Co-rich black mass was added into 40 ml solution in a closed bottle (slurry density 5 g/L). The mixture was heated with constant stirring at either 90° C. or 100° C. for 24 hours. As a control, 2 g of dried orange peels and 200 mg of Co-rich black mass was mixed in 40 ml DI water, and then leached under the same conditions. As shown in FIG. 6, the leaching efficiency of Li and Co of the extracts after hydrolysis, hydrothermal treatment and fermentation were above 80%, significantly higher than other samples. When compared to the control, an increase of about 50% in leaching efficiency of Co was observed. The data confirms the feasibility of fermentation, hydrolysis and hydrothermal treatment for reductive leaching.

To explain the improvement in the leaching efficiency, it should be noted that during fermentation and thermal treatment, saccharides are converted to more active components such as HMF, aldehydes, phenolic compounds and organic acids. The compounds have beneficial impact on the acidity as well as the reducing properties of the leaching solution. While heat or hydrothermal treatment also has exceptional leaching efficiency, the superiority of fermentation over other methods is scalability and less energy consumption. Kinetic studies of fermented leaching were investigated and explained in the following examples.

### Example 6b: Leaching Duration

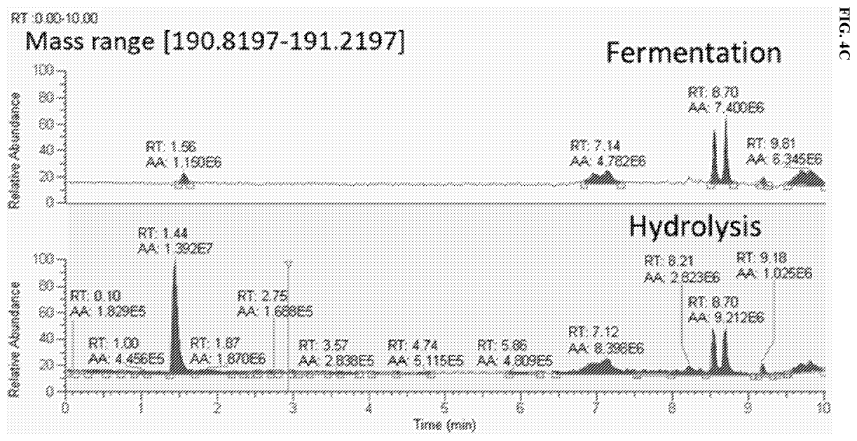

FIG. 7 shows the kinetic study of reductive leaching of battery waste powder in OP fermentation solution at 100° C. 500 mg of Co-rich black mass was dissolved in 100 ml of fermented orange extract (slurry density 5 g/L). Samples were taken after specific periods to measure the change in pH and leaching efficiency. The leaching efficiencies of Co and Li gradually increased by around 10% each hour. It is estimated that leaching efficiency could increase to above 90% after 10 hours. The pH of the leaching solution also increased with time, which is explained by the consumption of acid during the reaction.

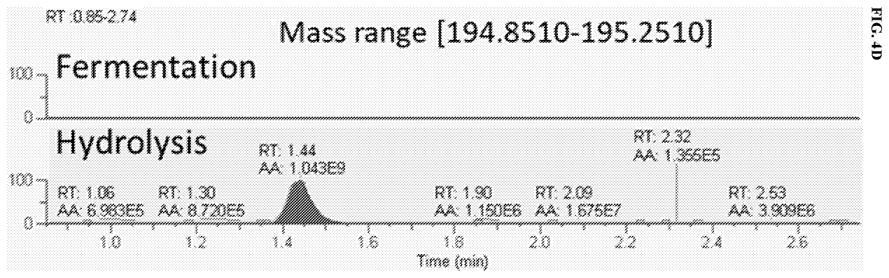

Orange peel (OP) was again used as fruit peel resource in the kinetic study. To eliminate the interference to the leaching system, the leaching rate of OP fermentation was re-assessed by another experiment set-up. Co-rich black mass was mixed in 10 ml of fermented orange extract (slurry density 5 g/L) in different glass bottles. The bottles were magnetic-stirred and heated in the same oil bath for 1, 2, 4, 8, 16 and 24 hours. Results are shown in FIG. 8a.

At 4 hours, the leaching efficiency increased to 96% for Li and 81% for Co while the leaching efficiency of Al and Cu reduced to 17% and ˜0% respectively. There were no significant changes in leaching efficiency after 4 hours. The results show that the leaching system is selective for Co and Li while the extraction of Cu and Al is minimal. Hereafter, the leaching duration was reduced to 4 hours.

A separate study was performed with microwave-treated orange extract on NMC black mass. 50 mg of NMC black mass was mixed in 10 ml of microwave treated extract (slurry density 5 g/L) in different glass bottles. The bottles were magnetic-stirred and heated in the same oil bath for 1, 2, 4, 8, 12 and 24 hours. The leaching temperature was set at 60° C. From FIG. 8b, the leaching efficiency plateaued at 12 hours of reaction and further decreased at 24 hours. Thus, it was concluded that an 8-hour leaching time is sufficient.

### Example 6c: Leaching pH and Temperature

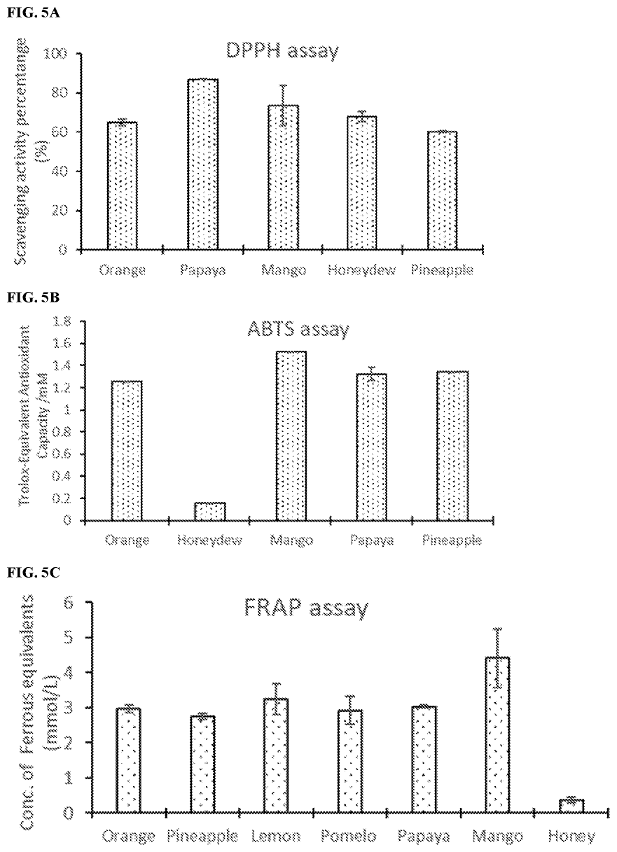

The relation between the initial acidity to leaching efficiency was examined by adjusting the initial pH of different batches of fermented orange extract by NaOH solution (FIG. 9a). Co-rich black mass was dissolved in fermented orange extract (slurry density 5 g/L) and reacted at different temperatures for 24 hours. As the initial pH increased, the leaching efficiency of the fermented samples, especially for Co metal, was observed to decrease. The initial pH of the leaching solution also correlated directly to the acidity of the leaching solution after reaction.

The dependence of leaching efficiency on the reaction temperature is illustrated in FIG. 9b. At 100° C., leaching efficiency increased significantly especially for Al. Despite the high leaching efficiency, the 100° C. solution had lower post-reaction pH than the 90° C. and 80° C. solutions, suggesting the formation of other acids during the leaching process especially at high temperatures. Conclusively, temperature and acidity are two important parameters that will influence the leaching reaction.

Further temperature-dependent studies were performed on NMC black mass using orange extracts treated using either the hydrothermal treatment or the microwave-assisted treatment. Hydrothermal orange extract and microwave orange extract was prepared following the conditions as described in the Example 2. The orange extracts were mixed with NMC black mass with a slurry density of 5 g/L. The dependence of leaching temperature to the leaching efficiency is illustrated in FIGS. 9c and 9d. For hydrothermal pre-treatment, the leaching efficiency increased with an increase in reaction temperature. Interestingly, when with microwave-assisted treatment, no significant changes in the leaching efficiency were observed at all tested temperatures (>60° C.). Noting that the leaching efficiency from microwave-assisted treatment remain constant at about 80%, while the leaching efficiency with hydrothermal treatment increased from about 60% at 50° C. to about 80% at 90° C., it appears that microwave assisted treatment is highly efficiency in converting sugars into active compounds key to the present invention. Whereas in the hydrothermal treatment, additional temperature is conducive for further conversion to active compounds and to further leach metal ions. Conclusively, the reaction temperature for hydrothermal leaching should be at 90° C. while leaching with microwave-treated fruit extracts may be performed at any temperature above 45° C.

### Example 6d: Leaching with Fermented Fruit Extracts

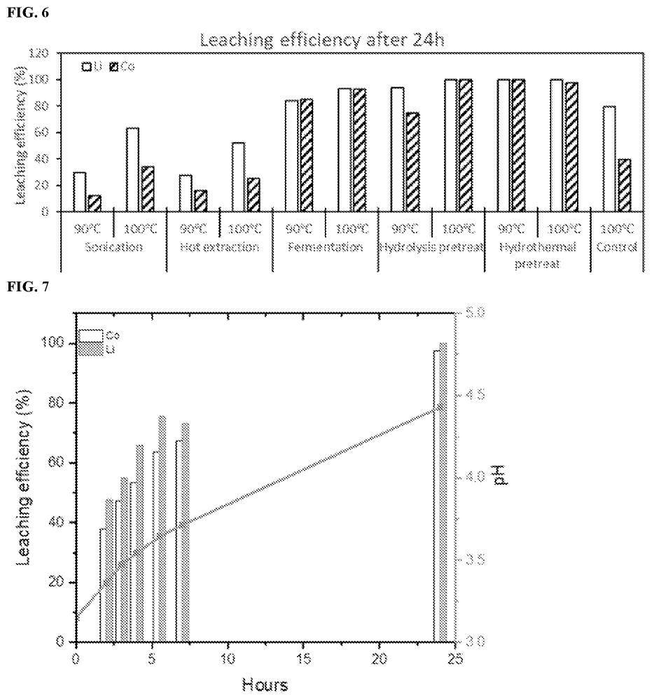

Similar leaching experiments were conducted using other fermented fruit extracts at different leaching temperatures with results shown in FIGS. 10a and 10b. In each reaction, 200 mg of Co-rich black mass was dissolved in 40 ml of fermented fruit extract (slurry density 5 g/L) and the reaction was performed for 24 hours. Orange, lemon, pomelo, mango, papaya, honeydew showed adequate leaching efficiencies (higher than 80%).

### Example 6e: Loading Capacity

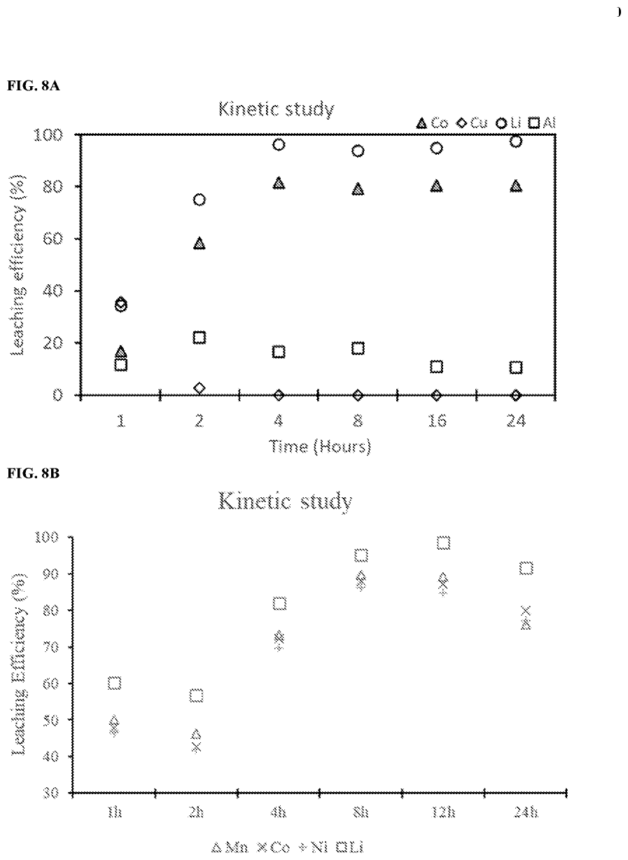

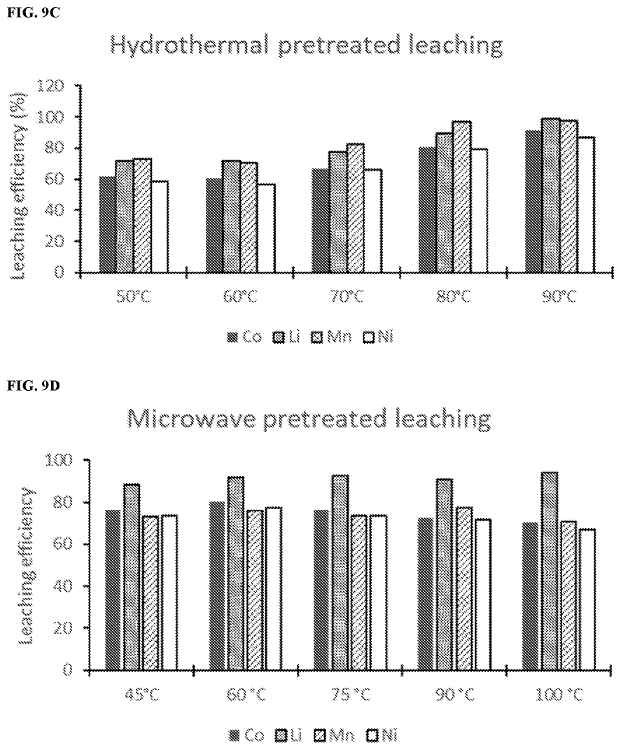

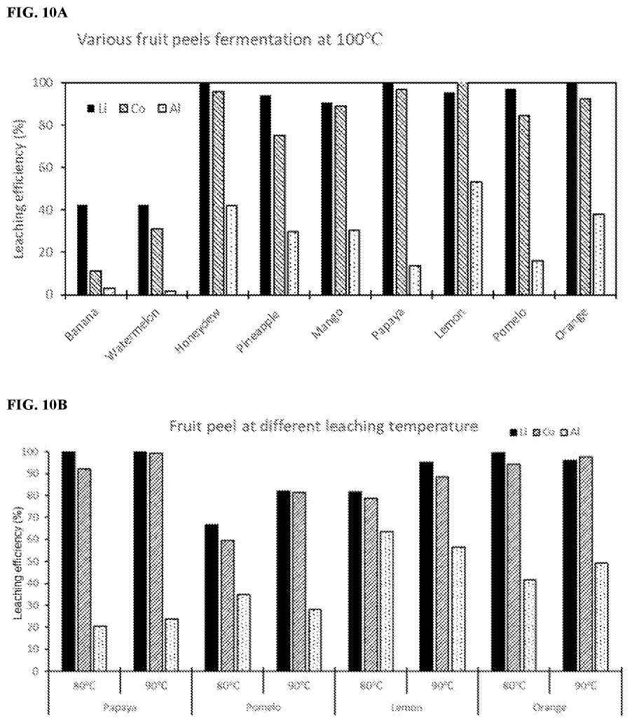

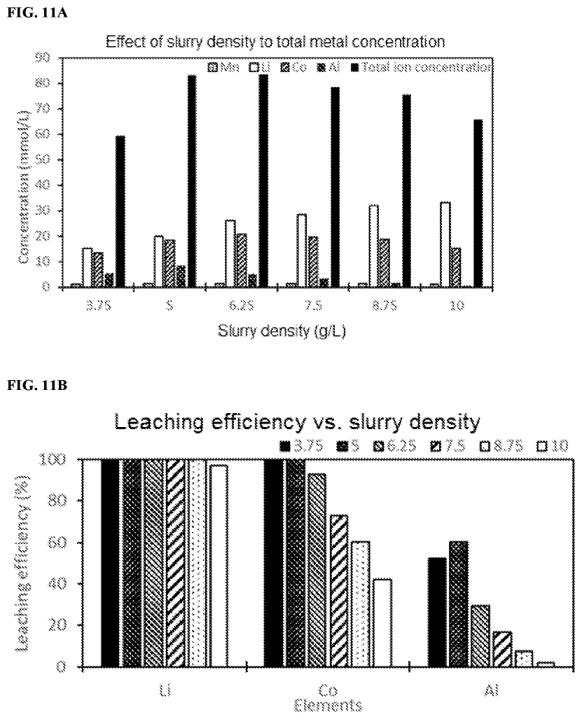

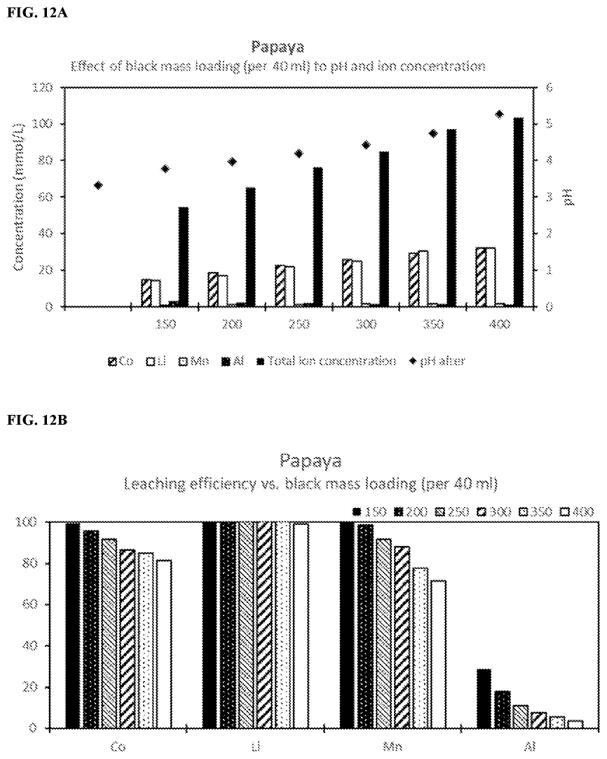

The leaching performance of these fermented fruit extracts are further described in FIGS. 11a to 16b. For all reactions, 150 mg to 400 mg of black mass were dissolved in 40 ml of fermented fruit extracts (slurry densities 2.5 g/L to 10 g/L) and the reaction was performed at 100° C. for 24 hours.

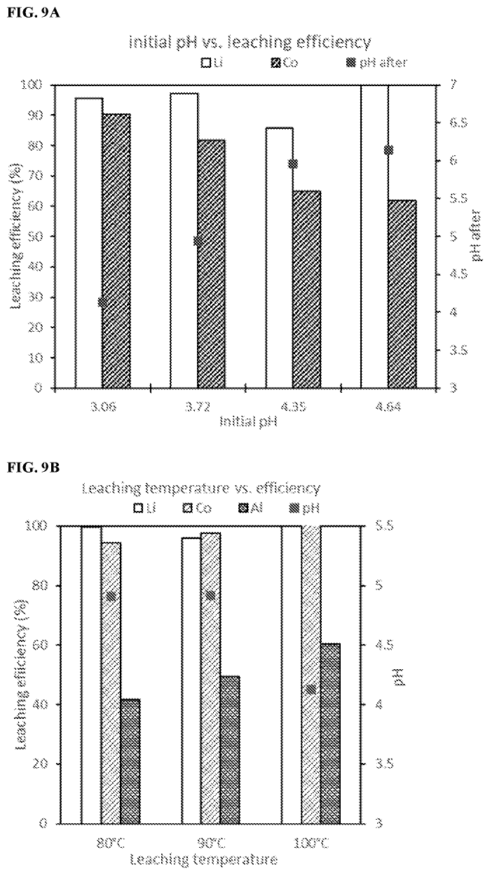

The fermented papaya extract showed the highest leaching efficiency among the fruits. In particular, the leaching efficiency of Co using papaya at 400 mg/40 ml (slurry density 10 g/L) slurry density was about 80% (FIGS. 12a and 12b). Their performance was also stable in a wide range of leaching temperatures. The results indicate that fruit fermentation is appropriate for battery leaching purpose.

Increasing the black mass concentration or slurry density from 150 mg to 400 mg per 40 ml of fermented extraction (slurry density 3.75 g/L to 10.0 g/L) for fermented orange extract reduced the leaching efficiencies especially for Co metal, which requires a reduction in valence states. Based on FIG. 11a, the optimal amount of black mass is 200-250 mg black mass for 40 ml of fermented fruit extract, corresponding to slurry densities from about 5 g/L to about 6.25 g/L. FIG. 11b indicates that the total metal ion concentration reached a saturated value at 6.25 g/L of slurry density and could not increase further. At this level of slurry density, the concentration of cobalt is saturated at 20 mmol/L. The saturation behaviour indicates the limitation of either the reducing agent or acidity of the fermented extract. The result instead also suggests the feasibility of selective Li leaching at higher mass loading.

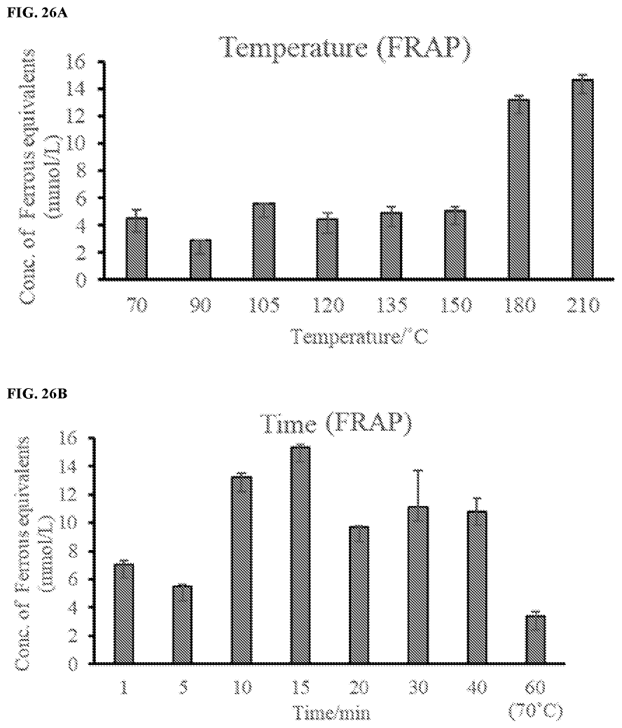

A separate loading capacity study was performed on NMC black mass with microwave treated orange extracts. Briefly, 50 mg to 250 mg of NMC black mass was dissolved in 10 ml of microwave-treated orange extract (slurry densities from 5 g/L to 25 g/L). The reaction was performed at 60° C. for 8 hours. Results are shown in FIG. 27. Similarly, increasing the slurry density from 5 g/L to 25 g/L decreased the leaching efficiency. Hence, 5 g/L slurry density appears to work equally well for microwave-treated fruit extracts and for NMC black mass.

### Example 6f: Leaching with Heat-Treated Extract

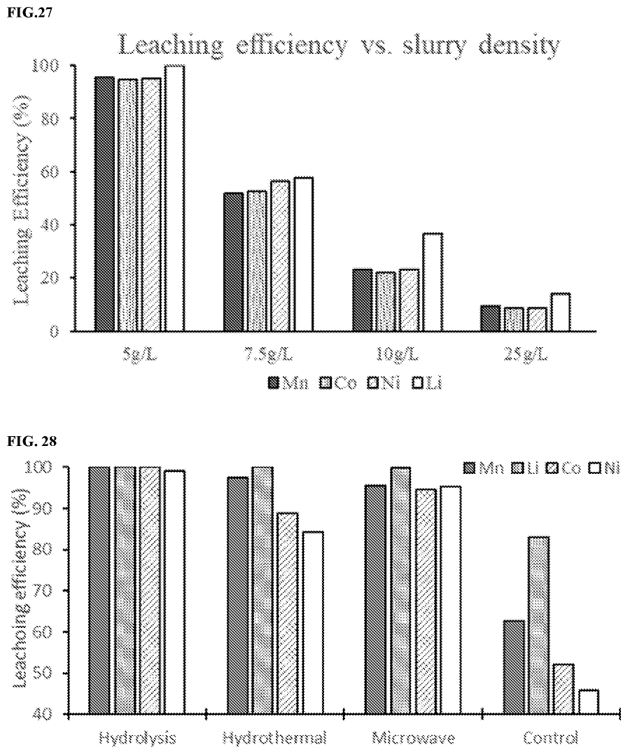

TABLE 5
Leaching conditions in FIG. 28

| | Hydrolysis | Hydrothermal | Microwave | Control |
|---|---|---|---|---|
| Slurry density | 5 g NMC black mass/L | | | |
| Temperature | 90 | 90 | 60 | 90 |
| (° C.) | | | | |
| Duration | 24 h | 24 h | 8 h | 24 h |
| Solvent | 40 ml of | 40 ml of | 40 ml of | 40 ml DI |
| | Hydrolysis | Hydrothermal | Microwave | water + |
| | extract | extract | extract | 4 g OP |

In order to compare leaching reaction of heat-treated extracts on NMC black mass, a control was tested, wherein a corresponding amount of orange peels were mixed directly with NMC black mass in DI water during the leaching reaction as described in Table 3. From FIG. 28, it was noted that the heat-treated orange extracts had significantly better leaching efficiency as compared to the control. Further, it was observed that the leaching efficiency of hydrothermal extract was slightly lower than other treatment methods. Hence, the results above also show the surprising effect of treatment on the fruit waste on their leaching efficiency.

A further pH study was performed with the fruit extracts obtained from hydrolysis at different durations in Example 2a. Results are shown in the “after leach” results in FIG. 24A. Results show that the pH post-reaction were generally around 4.5, even when the initial pH was around 3.7 for orange extracts treated for at least 3 days. This suggests that a significant amount of leaching had taken place, and that hydrolysis is surprisingly conducive to the leaching reaction.

### Example 6g: Extract Concentration

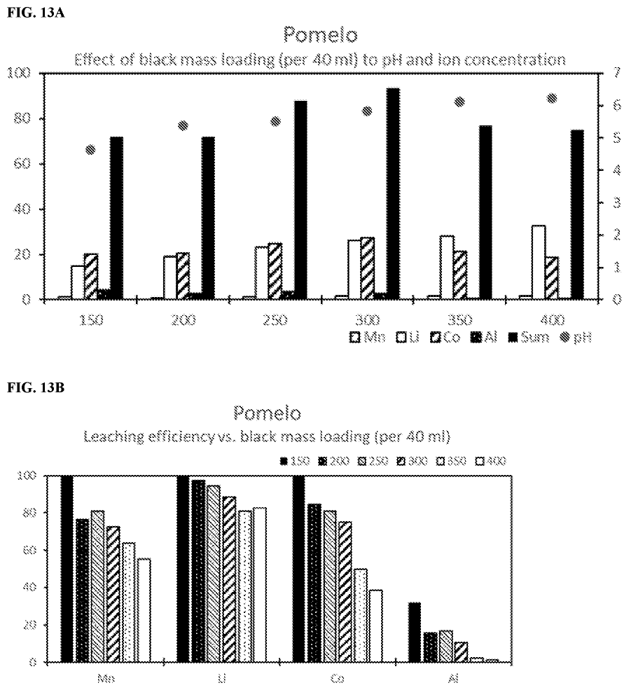

The optimal slurry density (black mass loading) was previously determined to be 5 g/L (or 200 mg/40 ml) according to the study done in Example 6e. To further develop the system to meet industrial demand, the following attempts mainly focused on increasing the slurry density of the hydrometallurgy reaction. Initial attempts focused on concentrating the fermented orange peel extracts. The fermented orange peel extract was concentrated to a quarter of its original volume by heating. Leaching reactions were performed at higher slurry densities than preceding tests, which is 10 g/L; the leaching reaction was performed at 100° C. for 4 hours (FIG. 17). Compared to the non-concentrated samples, the leaching efficiency increased by about 30%, from 35% to 66% for Co and from 67% to 91% for Li respectively. The results show that if the quality of fermented extract could be improved, the slurry density could be boosted further without affect leaching efficiency.

One postulation for the low slurry density is the insufficient acidity. Besides immense amounts of organic acids and antioxidants, fruit discards also contain high content of nutrient metals (such as Na, K), which also dissolve into the extract. The nutrient metals may neutralise organic acid and lead to the medium pH level of the extract (around 3-4). To improve the slurry density further, the extract may be protonated by simply adding a minor amount of acid, e.g. HCl.

### Example 6h: Acid Additive

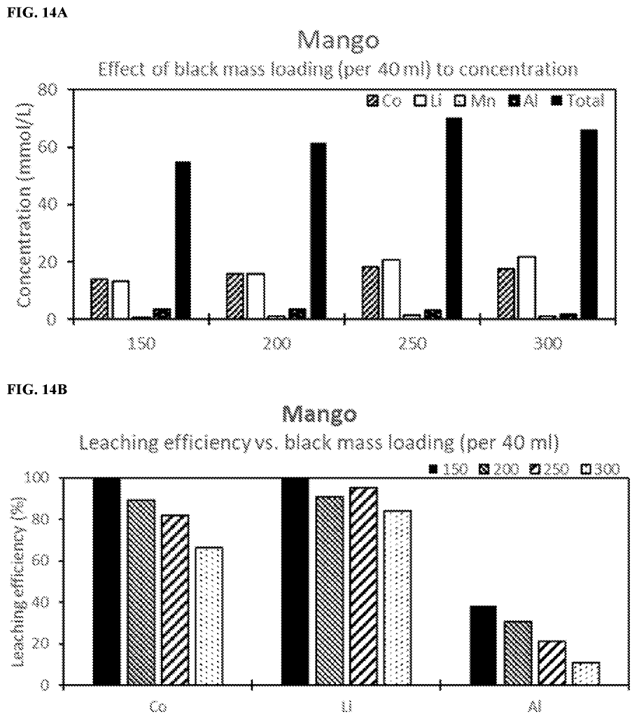

To test the postulation in Example 6g, 0 to 0.16 M of HCl was added to various extracts after fermentation and the extracts used in further leaching reactions. The leaching reaction was conducted in the same condition as Example 6f except that the slurry density was increased to 25 g/L, which is 5 times higher than the value found in Example 6e. From FIG. 18, in comparison to the un-modified sample (0% HCl), the leaching efficiency progressively increased from 5% (Co) and 19% (Li) to around 100% for all metals when adding 0.16 M of HCl. Cu and Al also started to dissolve into the solution with increasing HCl added. Meanwhile in the control sample (0.16 M HCl only), there were only around 25-40% of Co and Al leached into the solution. It was also noted that with 0.16 M of HCl addition, the pH of the fermented orange extract before reaction was around 0.55. On the other hand, the initial pH of the control without fermented orange extract was around 0.68. Remarkably, the pH of the same orange peel extract after reaction was around 3, ensuring the non-corrosiveness of the leachate. It should also be noted that, in conventional hydrometallurgy, the acid concentration used is around 2 M to 4 M. Hence, by using the leaching solution of the present invention, leaching efficiency could be maintained while only using 10% of the acid required in conventional methods.

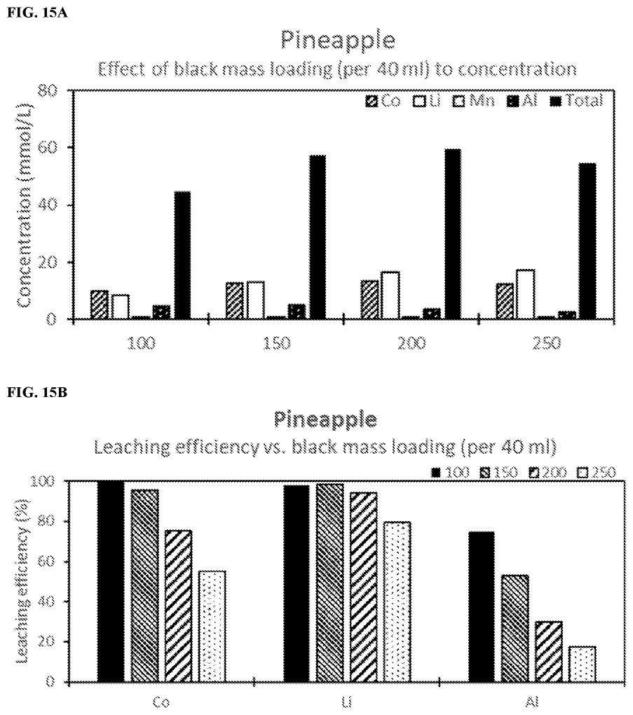

In FIG. 19, when HCl was replaced by citric acid (weak organic acid) with the same reaction conditions, there were no substantial changes in the leaching efficiency. It implies that the type of acid supplement does not play an important role in the effectiveness of the concoction.

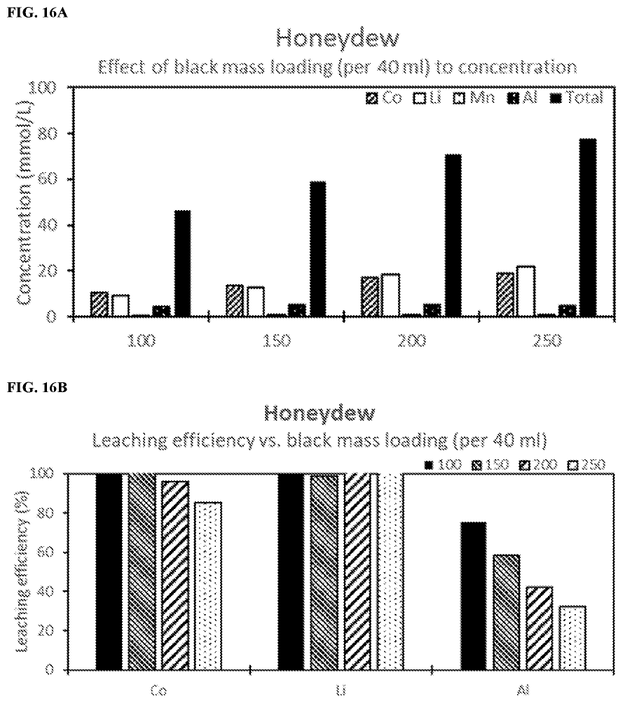

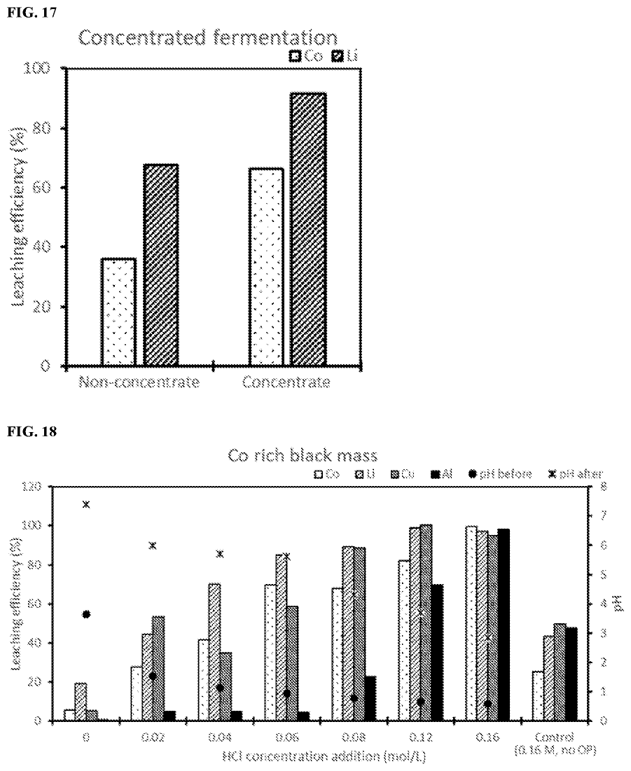

NMC black mass and Ni-rich black mass were further tested to confirm the effectiveness of acidified fermented OP concoction on other types of battery waste. For NMC black mass (FIG. 20), the extraction behavior of Ni and Mn are similar to Co. At the same slurry density of 25 g/L, the leaching efficiency reached around 100% with 0.16 M of HCl added. For the Ni-rich black mass (FIG. 21), 0.24 M of HCl was instead required to achieve the equivalent leaching efficiency for Li, Mn, Ni and Co.

It should be noted that in contrast to Co-rich and NMC black mass, there were less Al and Cu inside Ni-rich black mass and this was not accounted in the leaching efficiency calculation. In conclusion, fermented orange peel extracts with an acid supplement are capable of leaching several types of black masses, such as Co-rich, Ni-rich and NMC black mass at high slurry densities. The amount of acid consumption may vary depending on the type of the battery waste. Nevertheless, the concoction of the present invention requires significantly less acid compared to conventional leaching methods and would help to reduce the acid amount significantly.

### Example 6i: Heat-Treated Extract with Acid Additive for Leaching

Fermentation was established as an inventive treatment step the above-mentioned examples. The concept of adding acid as an additive was also explored in the other treatment processes, i.e. hydrolysis, hydrothermal and microwave-assisted treatment.

The optimal conditions for 3 treating the fruit extracts were previously explored in Example 2. The same procedure were used, except that the hydrothermal treatment was performed at 200° C. for 4 hours instead. The optimal leaching slurry density using the fruit extracts without any additives is 5 g black mass/L as discussed in Example 6e. To increase the slurry density of the methods, acid was also added into the extract as proton supplement.

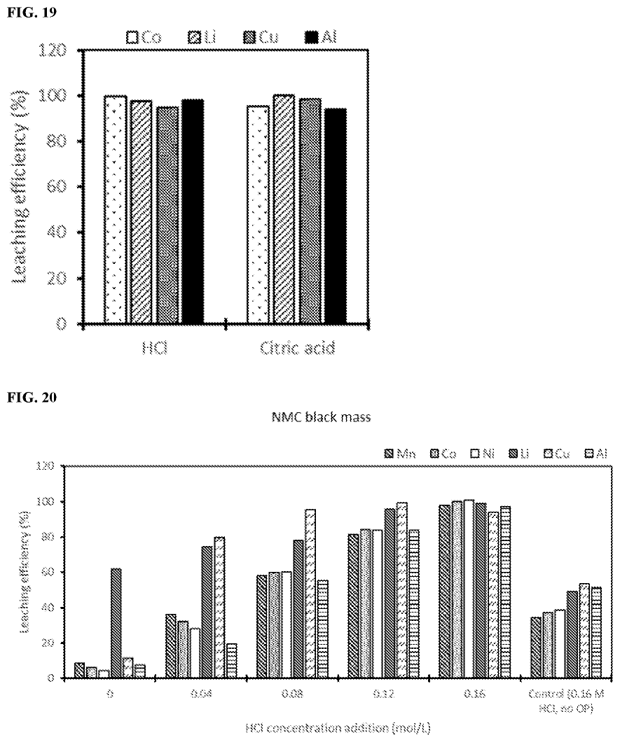

The general procedure outlined in Example 2 was used to obtain the heat treated orange extracts in the study. In this study, 0.16M of HCl was added into each heat treated extract and the slurry density of Co-rich black mass was increased to 25 g/L. The leaching temperature was kept at 100° C. and the reaction duration was 4 hours. As seen from FIG. 22, the leaching efficiency of Co, Li, Cu and Al were mostly above 90%. Hence, extracts from other treatment methods may also be used in combination with an acid additive to effectively extract metals from battery black mass.

### Example 7: Recovering Metal Ions

TABLE 6
Recovery efficiency of metal ions in non-concentrate after reaction

| | before | after | | Recovery |
|---|---|---|---|---|
| | precipitation | precipitation | Precipitate | efficiency |
| | (mg/L) | (mg/L) | (wt. %) | (%) |
| Co | 643.78 | 106.04 | 29.9 | 83.5 |
| Li | 112.45 | 117.82 | 1.5 | 0 |
| Mn | 48.98 | 8.80 | 2.1 | 82.0 |
| Cu | 11.41 | 14.67 | 1.7 | 0 |
| Ni | 6.61 | 4.18 | 0.1 | 36.7 |
| Fe | 1.86 | 0.93 | 0.8 | 50.0 |
| Al | 32.69 | 33.47 | 1.3 | 0.0 |

TABLE 7
Recovery efficiency of metal ions in concentrate
after reaction precipitation

| | before | after | | Recovery |
|---|---|---|---|---|
| | precipitation | precipitation | Precipitate | efficiency |
| | (mg/L) | (mg/L) | (wt. %) | (%) |
| Co | 5810 | 106.04 | 21.29 | 98.2 |
| Li | 1573 | 1002.83 | 0.11 | 36.2 |
| Mn | 723.696 | 183.33 | 1.82 | 74.7 |
| Cu | 272.9 | 192.5 | 0.55 | 29.5 |
| Ni | 88 | 192.5 | 0.21 | N/A |
| Fe | 189.9 | N.D. | 0.18 | N/A |
| Al | 461.65 | 33.47 | 0.07 | N/A |

Importantly, the metal ions in the leachate (Co, Mn and Ni) could be recovered using simple oxalate precipitation with high recovery efficiency. Results are shown in Table 3 and Table 4. The precipitate contains tare levels of impurities (Cu, Fe and Al). Therefore, the precipitate could be used directly in the synthesis of cathode material for Li-ion batteries. The recovery efficiency improved further to above 95% when the leachate was concentrated (Example 6f).

In conclusion, our preliminary data demonstrated the feasibility and potential of the invention in valorising treated fruit extracts for recycling waste LIBs. Because of the similarity in chemical properties of Mn, Co and Ni, this invention is applicable for all types of Li-ion battery waste containing Mn, Co and Ni metals.

### INDUSTRIAL APPLICABILITY

The present invention relates to a method of recovering metal ions from battery waste, comprising treating fruit waste by fermentation or heat treatment to obtain a leaching solution. The disclosed methods may not require a secondary acid and/or oxidant in the leaching process as compared to conventional methods. The disclosed methods also valorizes two types of waste simultaneously, i.e. fruit waste and battery waste which is a significant step towards a circular and zero-waste economy. The disclosed method also does not produce hazardous and corrosive waste that require significant amount of treatment. Therefore, it holds great promise for hydrometallurgy to be widely applied into LIBs recycling industries and supersede the unsustainable pyrometallurgical approaches. Thus the present invention is capable of industrial applicability.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of obtaining metal ions from a battery, the method comprising:
(i) adding fruit to a solvent to form a mixture;
(ii) subjecting the mixture of step (i) to fermentation or heat treatment to obtain a leaching solution; and
(iii) adding a crushed battery to the leaching solution thereby obtaining a leachate comprising metal ions.

2. The method of claim 1, wherein the pH of the leaching solution is about 3 to about 5.

3. The method of claim 1 or 2, wherein step (ii) of claim 1 further comprises adding a fermentation starter to the mixture.

4. The method of claim 3, wherein the fermentation starter is selected from the group consisting of whey; yeast; kombucha; kefir; sourdough; bacterial strains selected from the group consisting of Acetobacters, Escherichia, Citrobacter, Enterobacter, Klebsiella, Lactobacillaceae and Streptococcacea; and mixtures thereof.

5. The method of claim 1 or 2, wherein step (ii) of claim 1 further comprises heating the mixture at a temperature from about 60° C. to about 220° C.

6. The method of any one of claims 1, 2 or 5, wherein the duration of heat treatment is in the range of about 2 hours to about 80 hours.

7. The method of any one of claims 1, 2, or 5, wherein the heat treatment is a microwave-assisted heat treatment.

8. The method of claim 7, wherein the duration of the microwave-assisted heat treatment is about 10 minutes to about 90 minutes.

9. The method of any one of claims 1 to 8, further comprising the step of
(iia) before step (iii), adding an acid to the leaching solution of step (ii) to obtain an acidified leaching solution, and adding the crushed battery to the acidified leaching solution thereby obtaining a leachate comprising metal ions.

10. The method of claim 9, wherein the pH of the acidified leaching solution is in the range of about 0.4 to about 2.2.

11. The method of claim 9 or 10, wherein the concentration of acid added is about 0.04 M to about 0.3 M.

12. The method of any one of claims 9 to 11, wherein the acid is selected from the group consisting of hydrochloric acid, nitric acid, phosphoric acid, sulfuric acid, citric acid, acetic acid, tartaric acid, maleic acid, oxalic acid, L-ascorbic acid, succinic acid, quininic acid, isocitric acid, tannic acid, caffeic acid, lactic acid, formic acid, uric acid, barbituric acid, benzenesulfonic acid, benzoic acid, bromoacetic acid, chloroacetic acid, fumaric acid, gallic acid, methane sulfonic acid, phthalic acid, propionic acid, salicylic acid, sorbic acid, p-toluene sulfonic acid, fluoroantimonic acid, erucic acid, lauric acid, butyric acid, and mixtures thereof.

13. The method of any one of claims 1 to 12, wherein the concentration of the fruit in the solvent is in the range of about 5 g/L to about 200 g/L.

14. The method of any one of claims 1 to 13, wherein the density of the crushed battery in the leaching solution (w_{crushed battery}/v_{leaching solution}) or acidified leaching solution (w_{crushed battery}/v_{acidified leaching solution}) is in the range of about 1 g/L to about 100 g/L.

15. The method of any one of claims 1 to 14, wherein the fruit is selected from the group consisting of orange, lemon, lime, pomelo, pineapple, papaya, mango, honeydew, melon, pear, apple, banana, blackberry, raspberry, cranberry, tamarind, grape, watermelon, kiwi, plum, peach, sweet potato, avocado, cucumber, dragon fruit, guava, jackfruit, durian, beetroot, carrot, soursop, and mixtures thereof,
and wherein the fruit comprises its peel, flesh and/or seeds.

16. The method of any one of claims 1 to 15, wherein the fruit is primarily fruit peel.

17. The method of any one of claims 1 to 16, wherein the fruit is in powder or blended form.

18. The method of any one of claims 1 to 17, wherein the metal ions comprise nickel, manganese cobalt, lithium, zinc, iron, silver, vanadium, silicon, titanium, tin, chromium, copper, and/or aluminium ions.

19. A method of obtaining a metal salt from a battery, the method comprising:
(i) adding fruit to a solvent to form a mixture;
(ii) subjecting the mixture of step (i) to fermentation or heat treatment to obtain a leaching solution;
(iii) adding a crushed battery to the leaching solution thereby obtaining a leachate comprising metal ions; and
(iv) adding a precipitating agent to the leachate to obtain a precipitate comprising the metal salt.

20. The method of claim 19, wherein the precipitating agent is selected from the group consisting of sodium hydroxide, sodium chloride, sodium bisulfate, monosodium phosphate, disodium phosphate, trisodium phosphate, sodium carbonate, sodium bicarbonate, sodium sulfite, sodium bisulfite, calcium hydroxide, potassium hydroxide, potassium chloride, potassium carbonate, potassium bicarbonate, sodium oxalate, ammonium oxalate, ammonium hydroxide, ammonium bisulfate, ammonium phosphate, ammonium carbonate, ammonium bicarbonate, ammonium sulfite, oxalic acid, phosphoric acid, carbonic acid, magnesium hydroxide and any mixture thereof.

21. The method of claim 19 or 20, wherein the precipitate comprises cobalt salt, manganese salt and/or nickel salt.

22. The method of any one of claims 1 to 21, wherein the battery is a metal ion battery.

23. The method of claim 22, wherein the metal ions of the metal ion battery are selected from the group consisting of aluminium ions, lithium ions, potassium ions, magnesium ions, zinc ions, sodium ions, and combinations thereof.

24. The method of any one of claims 1 to 23, wherein the battery is selected from the group consisting of an NMC 111 battery, an NMC 622 battery, a Lithium Nickel Cobalt Aluminium Oxide battery, a Lithium Cobalt Oxide battery, a Lithium Nickel Oxide battery, a Lithium Manganese Oxide battery, a Lithium Nickel Manganese Cobalt Oxide battery, a lithium titanate battery, a lithium iron phosphate battery, a lithium manganese dioxide battery, a lithium manganese nickel battery, a lithium manganese phosphate battery, a lithium nickel phosphate battery, a lithium cobalt phosphate battery, a lithium-ion polymer battery, a thin-film lithium-ion battery, a lithium silicon battery, or a NMC 811 battery, or any combinations and mixtures thereof.

25. A method of recovering and regenerating a lithium cathode material from a lithium-ion battery (LIB), the method comprising:
(i) adding fruit to a solvent to form a mixture;
(ii) subjecting the mixture of step (i) to fermentation or heat treatment to obtain a leaching solution;
(iii) adding a crushed LIB to the leaching solution thereby obtaining a leachate comprising metal ions;
(iv) adding a precipitating agent to the leachate of step (iii), thereby obtaining a precipitate comprising metal salt; and
(v) mixing the precipitate of step (iv) with a lithium salt and heating the resulting mixture to obtain a lithium cathode material.

26. The method of claim 25, wherein the lithium salt is selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

27. The method of claim 25 or 26, wherein the lithium cathode material is selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium nickel oxide (LiNiO₂), lithium manganese dioxide (LiMnO₂), lithium manganese nickel oxide (LiNi_{0.5}Mn_{1.5}O₄)(LMNO), lithium manganese phosphate (LiMnPO₄), lithium nickel phosphate (LiNiPO₄), lithium cobalt phosphate (LiCoPO₄), lithium nickel cobalt aluminium oxide (LiNi_{0.8}CoAl_{0.05}O₂), and any mixture thereof.
